(19) United States
(12) Patent Application Publication
(10) Pub. No.: US 2013/0083220 A1
(43) Pub. Date: Apr. 4, 2013

(54) IMAGE PROCESSING DEVICE, IMAGING DEVICE, INFORMATION STORAGE DEVICE, AND IMAGE PROCESSING METHOD

(71) Applicant: OLYMPUS CORPORATION, Tokyo (JP)

(72) Inventor: Shinichi IMADE, Iruma-shi, Saitama (JP)

(73) Assignee: OLYMPUS CORPORATION, Tokyo (JP)

(21) Appl. No.: 13/685,058

(22) Filed: Nov. 26, 2012

Related U.S. Application Data
(63) Continuation of application No. PCT/JP2011/060501, filed on May 2, 2011.

(30) Foreign Application Priority Data
May 26, 2010 (JP) 2010-120325

(51) Int. Cl. H04N 5/262

(52) U.S. Cl. CPC H04N 5/262
USPC 348/239

(57) ABSTRACT

The image processing device includes a storage section, an interpolation section, an estimation calculation section, and an image output section. A low-resolution frame image is acquired by reading light-receiving values of light-receiving units. The storage section stores the low-resolution frame image. The interpolation section calculates light-receiving values of virtual light-receiving units by an interpolation process based on the light-receiving values. The estimation calculation section estimates estimated pixel values at a pixel pitch smaller than that of the low-resolution frame image based on the light-receiving value of the light-receiving unit and the light-receiving values of the virtual light-receiving units. The image output section outputs a high-resolution frame image having a resolution higher than that of the low-resolution frame image based on the estimated pixel values.

### CROSS REFERENCE TO RELATED APPLICATION

This application is a continuation of International Patent Application No. PCT/JP2011/60501, having an international filing date of May 2, 2011, which designated the United States, the entirety of which is incorporated herein by reference. Japanese Patent Application No. 2010-120325 filed on May 26, 2010 is also incorporated herein by reference in its entirety.

### BACKGROUND

The present invention relates to an image processing device, an imaging device, an information storage device, an image processing method, and the like.

A digital camera or a video camera may be designed so that the user can select a still image shooting mode or a movie shooting mode. For example, a digital camera or a video camera may be designed so that the user can shoot a still image having a resolution higher than that of a movie by operating a button when shooting a movie.

The inventor of the invention proposes generating a high-resolution still image at an arbitrary timing from a low-resolution movie in order to shoot the best moment. JP-A-2009-124621 and JP-A-2008-243037 disclose a method that generates (synthesizes) a high-resolution image from low-resolution images acquired using a pixel shift method, for example.

### BRIEF DESCRIPTION OF THE DRAWINGS

FIG. 1 is a view illustrating a light-receiving value interpolation method.

FIGS. 2A and 2B are views illustrating an estimation block and a light-receiving unit.

FIGS. 3A and 3B are views illustrating an estimated pixel value and an intermediate pixel value.

FIG. 4 is a view illustrating a first estimated pixel value estimation method.

FIG. 5 is a view illustrating a first estimated pixel value estimation method.

FIG. 6 is a view illustrating a first estimated pixel value estimation method.

FIGS. 7A and 7B are views illustrating an intermediate pixel value and an estimated pixel value.

FIG. 8 is a view illustrating a first estimated pixel value estimation method.

FIG. 9 is a view illustrating a first estimated pixel value estimation method.

FIG. 10 is a view illustrating a first estimated pixel value estimation method.

FIG. 11 illustrates a first configuration example of an imaging device and an image processing device.

FIG. 12 is a view illustrating an interpolation method when shooting a movie.

FIG. 13 is a view illustrating a second estimated pixel value estimation method.

FIGS. 14A and 14B are views illustrating a fourth estimated pixel value estimation method.

FIG. 15 is a view illustrating a third estimated pixel value estimation method.

FIG. 16 is a view illustrating a third estimated pixel value estimation method.

FIGS. 17A and 17B are views illustrating a third estimated pixel value estimation method.

FIG. 18 is a view illustrating a data compression/decompression process and an estimation process.

FIG. 19 is a view illustrating a data compression/decompression process and an estimation process.

FIG. 20 illustrates a second configuration example of an imaging device and an image processing device.

FIG. 21 is a view illustrating a fourth estimated pixel value estimation method.

FIGS. 22A and 22B are views illustrating a fourth estimated pixel value estimation method.

FIG. 23 is a view illustrating a fourth estimated pixel value estimation method.

FIG. 24 is a view illustrating a fourth estimated pixel value estimation method.

FIG. 25 is a view illustrating a fourth estimated pixel value estimation method.

FIG. 26 is a view illustrating a fourth estimated pixel value estimation method.

FIG. 27 is a view illustrating a fourth estimated pixel value estimation method.

FIG. 28 is a view illustrating a fourth estimated pixel value estimation method.

FIG. 29 is a flowchart illustrating a fifth estimated pixel value estimation method.

FIG. 30 is a view illustrating a sixth estimated pixel value estimation method.

FIG. 31 is a flowchart illustrating a sixth estimated pixel value estimation method.

FIGS. 32A and 32B are views illustrating a seventh estimated pixel value estimation method.

FIG. 33 illustrates a third configuration example of an imaging device and an image processing device.

### SUMMARY

According to one aspect of the invention, there is provided an image processing device comprising:

a storage section that stores a low-resolution frame image being acquired by reading light-receiving values of light-receiving units, the light-receiving units being units for acquiring the light-receiving values and set on an image sensor;

an interpolation section that calculates light-receiving values of virtual light-receiving units by an interpolation process based on the light-receiving values of the light-receiving units of the low-resolution frame image, the virtual light-receiving units being set to overlap a corresponding light-receiving unit and being shifted from a position of the corresponding light-receiving unit;

an estimation calculation section that estimates estimated pixel values at a pixel pitch smaller than that of the low-resolution frame image based on the light-receiving value of the corresponding light-receiving unit and the light-receiving values of the virtual light-receiving units; and

an image output section that outputs a high-resolution frame image having a resolution higher than that of the low-resolution frame image based on the estimated pixel values estimated by the estimation calculation section.

According to another embodiment of the invention, there is provided an imaging device comprising:

an image sensor;

a readout control section that acquires a low-resolution frame image by reading light-receiving values of light-receiving units, the light-receiving units being units for acquiring the light-receiving values and set on the image sensor;

a storage section that stores the low-resolution frame image acquired by the readout control section;

an interpolation section that calculates light-receiving values of virtual light-receiving units by an interpolation process based on the light-receiving values of the light-receiving units of the low-resolution frame image, the virtual light-receiving units being set to overlap a corresponding light-receiving unit and being shifted from a position of the corresponding light-receiving unit;

an estimation calculation section that estimates estimated pixel values at a pixel pitch smaller than that of the low-resolution frame image based on the light-receiving value of the corresponding light-receiving unit and the light-receiving values of the virtual light-receiving units; and

an image output section that outputs a high-resolution frame image having a resolution higher than that of the low-resolution frame image based on the estimated pixel values estimated by the estimation calculation section.

According to another embodiment of the invention, there is provided an information storage device that stores a program,

the program that causes a computer to function as:

a storage section that stores a low-resolution frame image being acquired by reading light-receiving values of light-receiving units, the light-receiving units being units for acquiring the light-receiving values and set on an image sensor;

an interpolation section that calculates light-receiving values of virtual light-receiving units by an interpolation process based on the light-receiving values of the light-receiving units of the low-resolution frame image, the virtual light-receiving units being set to overlap a corresponding light-receiving unit and being shifted from a position of the corresponding light-receiving unit;

an estimation calculation section that estimates estimated pixel values at a pixel pitch smaller than that of the low-resolution frame image based on the light-receiving value of the corresponding light-receiving unit and the light-receiving values of the virtual light-receiving units; and

an image output section that outputs a high-resolution frame image having a resolution higher than that of the low-resolution frame image based on the estimated pixel values estimated by the estimation calculation section.

According to another embodiment of the invention, there is provided an image processing method comprising:

storing a low-resolution frame image being acquired by reading light-receiving values of light-receiving units, the light-receiving units being units for acquiring the light-receiving values and set on an image sensor;

calculating light-receiving values of virtual light-receiving units by an interpolation process based on the light-receiving values of the light-receiving units of the low-resolution frame image, the virtual light-receiving units being set to overlap a corresponding light-receiving unit and being shifted from a position of the corresponding light-receiving unit;

estimating estimated pixel values at a pixel pitch smaller than that of the low-resolution frame image based on the light-receiving value of the corresponding light-receiving unit and the light-receiving values of the virtual light-receiving units; and

outputting a high-resolution frame image having a resolution higher than that of the low-resolution frame image based on the estimated pixel values.

### DESCRIPTION OF EXEMPLARY EMBODIMENTS

Several embodiments of the invention may provide an image processing device, an imaging device, an information storage device, an image processing method, and the like that can acquire a high-resolution image from a low-resolution movie using a simple process.

According to one embodiment of the invention, there is provided an image processing device comprising:

a storage section that stores a low-resolution frame image being acquired by reading light-receiving values of light-receiving units, the light-receiving units being units for acquiring the light-receiving values and set on an image sensor;

an interpolation section that calculates light-receiving values of virtual light-receiving units by an interpolation process based on the light-receiving values of the light-receiving units of the low-resolution frame image, the virtual light-receiving units being set to overlap a corresponding light-receiving unit and being shifted from a position of the corresponding light-receiving unit;

an estimation calculation section that estimates estimated pixel values at a pixel pitch smaller than that of the low-resolution frame image based on the light-receiving value of the corresponding light-receiving unit and the light-receiving values of the virtual light-receiving units; and

an image output section that outputs a high-resolution frame image having a resolution higher than that of the low-resolution frame image based on the estimated pixel values estimated by the estimation calculation section.

According to this embodiment of the invention, the light-receiving values of the virtual light-receiving units are calculated by the interpolation process based on the light-receiving values of the light-receiving units. The estimated pixel values at a pixel pitch smaller than that of the low-resolution frame image are estimated based on the light-receiving values of the virtual light-receiving units and the light-receiving value of the corresponding light-receiving unit. A high-resolution frame image having a resolution higher than that of the low-resolution frame image is output based on the estimated pixel values. This makes it possible to acquire a high-resolution image from a low-resolution movie using a simple process, for example.

In the image processing device,

the estimation calculation section may calculate a difference between the light-receiving value of a first light-receiving unit and the light-receiving value of a second light-receiving unit, and may estimate the estimated pixel values based on the difference, the first light-receiving unit being the corresponding light-receiving unit or a virtual light-receiving unit among the virtual light-receiving units that is set at a first position, and the second light-receiving unit being a virtual light-receiving unit among the virtual light-receiving units that is set at a second position and overlaps the first light-receiving unit.

It is possible to estimate the estimated pixel values based on the light-receiving value of the corresponding light-receiving unit and the light-receiving values of the virtual light-receiving units by thus estimating the estimated pixel values based on the difference between the light-receiving value of the first light-receiving unit and the light-receiving value of the second light-receiving unit.

In the image processing device,

the estimation calculation section may express a relational expression of a first intermediate pixel value and a second intermediate pixel value using the difference, the first intermediate pixel value being the light-receiving value of a first light-receiving area that is obtained by removing an overlapping area from the first light-receiving unit, and the second intermediate pixel value being the light-receiving value of a second light-receiving area that is obtained by removing the overlapping area from the second light-receiving unit, and

the estimation calculation section may estimate the first intermediate pixel value and the second intermediate pixel value using the relational expression, and may calculate the estimated pixel values using the estimated first intermediate pixel value.

In the image processing device,

the estimation calculation section may express a relational expression of intermediate pixel values included in an intermediate pixel value pattern using the light-receiving value of the corresponding light-receiving unit and the light-receiving values of the virtual light-receiving units, the intermediate pixel value pattern including consecutive intermediate pixel values that include the first intermediate pixel value and the second intermediate pixel value,

the estimation calculation section may compare the intermediate pixel value pattern expressed by the relational expression and a light-receiving value pattern expressed using the light-receiving value of the corresponding light-receiving unit and the light-receiving values of the virtual light-receiving units to evaluate similarity, and

the estimation calculation section may determine the intermediate pixel values included in the intermediate pixel value pattern based on a similarity evaluation result so that the similarity becomes a maximum.

In the image processing device,

the estimation calculation section may express a relational expression of intermediate pixel values included in an intermediate pixel value pattern using the light-receiving value of the corresponding light-receiving unit and the light-receiving values of the virtual light-receiving units, the intermediate pixel value pattern including consecutive intermediate pixel values that include the first intermediate pixel value and the second intermediate pixel value, may compare the intermediate pixel value pattern expressed by the relational expression and a light-receiving value pattern expressed using the light-receiving value of the corresponding light-receiving unit and the light-receiving values of the virtual light-receiving units to evaluate similarity, and may determine the intermediate pixel values included in the intermediate pixel value pattern based on a similarity evaluation result so that the similarity becomes a maximum.

It is possible to determine the intermediate pixel values based on the relational expression of the intermediate pixel values by thus comparing the intermediate pixel value pattern and the light-receiving value pattern to evaluate the similarity, and determining the intermediate pixel values included in the intermediate pixel value pattern so that the similarity becomes a maximum.

In the image processing device,

the estimation calculation section may calculate an evaluation function that indicates an error between the intermediate pixel value pattern expressed by the relational expression and the light-receiving value pattern, and may determine the intermediate pixel values included in the intermediate pixel value pattern so that a value of the evaluation function becomes a minimum.

The similarity between the intermediate pixel value pattern and the light-receiving value pattern can be evaluated by thus calculating the evaluation function. It is also possible to determine the intermediate pixel values so that the similarity becomes a maximum by determining the intermediate pixel values so that the value of the evaluation function becomes a minimum.

In the image processing device,

the interpolation section may calculate a weighted sum of the light-receiving values of a plurality of light-receiving units that are included in the low-resolution frame image and positioned around each of the virtual light-receiving units to calculate the light-receiving values of the virtual light-receiving units.

This makes it possible to calculate the light-receiving values of the virtual light-receiving units by the interpolation process based on the light-receiving value of the light-receiving unit of the low-resolution frame image.

In the image processing device,

the light-receiving units may be set to include a plurality of pixels of the image sensor, pixel values of the plurality of pixels respectively included in the light-receiving units may be summed up, and read as the light-receiving values of the light-receiving units, and

the estimation calculation section may estimate the pixel values of the plurality of pixels respectively included in the light-receiving units based on the light-receiving values of the light-receiving units.

This makes it possible to estimate the pixel value of each pixel of the light-receiving unit based on the light-receiving value of the light-receiving unit obtained by the addition readout process.

In the image processing device,

the light-receiving units may be set to include a plurality of pixels of the image sensor, pixel values of the plurality of pixels respectively included in the light-receiving units may be summed up with weighting, and read as the light-receiving values of the light-receiving units, and

the estimation calculation section may estimate the pixel values of the plurality of pixels respectively included in the light-receiving units based on the light-receiving values of the light-receiving units.

This makes it possible to estimate the pixel value of each pixel of the light-receiving unit based on the light-receiving value of the light-receiving unit obtained by the weighted summation readout process.

In the image processing device,

the image sensor may be a color image sensor, a plurality of pixels adjacent to each other may be set as the light-receiving units independently of a color of each pixel, pixel values of the plurality of pixels set as the light-receiving units may be summed up, and read to acquire the low-resolution frame image,

the estimation calculation section may estimate the pixel values of each pixel of the light-receiving units based on the light-receiving values of the light-receiving units of the low-resolution frame image and the light-receiving values of the virtual light-receiving units output from the interpolation section, and

the image output section may output a high-resolution color frame image based on the pixel values estimated by the estimation calculation section.

In the image processing device,

the image sensor may be a color image sensor, a plurality of pixels in an identical color may be set as the light-receiving units, pixel values of the plurality of pixels set as the light-receiving units may be summed up, and read to acquire the low-resolution frame image,

the estimation calculation section may estimate the pixel value of each pixels of the light-receiving units based on the light-receiving values of the light-receiving units of the low-resolution frame image and the light-receiving values of the virtual light-receiving units output from the interpolation section, and

the image output section may output a high-resolution color frame image based on the pixel values estimated by the estimation calculation section.

This makes it possible to estimate the estimated pixel values from the low-resolution frame image acquired by the color image sensor, and output a high-resolution color frame image.

In the image processing device,

the light-receiving units may be set to include N×N pixels, pixel values of the N×N pixels may be summed up, and read to acquire the light-receiving value of each N×N-pixel light-receiving unit,

the interpolation section may calculate the light-receiving value of each N×N-pixel virtual light-receiving unit shifted by N/2 pixels with respect to each N×N-pixel light-receiving unit by performing the interpolation process,

the estimation calculation section may estimate the light-receiving value of each N/2×N/2-pixel light-receiving unit based on the light-receiving value of each N×N-pixel light-receiving unit and the light-receiving value of each N×N-pixel virtual light-receiving unit,

the interpolation section may calculate the light-receiving value of each N/2×N/2-pixel virtual light-receiving unit shifted by N/4 pixels with respect to each N/2×N/2-pixel light-receiving unit by performing the interpolation process, and

the estimation calculation section may estimate the light-receiving value of each N/4×N/4-pixel light-receiving unit based on the light-receiving value of each N/2×N/2-pixel light-receiving unit and the light-receiving value of each N/2×N/2-pixel virtual light-receiving unit.

This makes it possible to estimate the light-receiving value of the N/2×N/2-pixel light-receiving unit from the light-receiving value of the N×N-pixel light-receiving unit, and estimate the light-receiving value of the N/4×N/4-pixel light-receiving unit from the light-receiving value of the N/2×N/2-pixel light-receiving unit. This makes it possible to estimate the estimated pixel values by sequentially repeating the estimation process.

In the image processing device,

a pixel shift process that shifts the light-receiving units so that overlap occurs may be performed in each frame, the corresponding light-receiving unit may be sequentially set at a plurality of positions by the pixel shift process, and set at an identical position at intervals of a plurality of frames,

the interpolation section may calculate the light-receiving values of the virtual light-receiving units in each frame by the interpolation process based on the low-resolution frame image acquired in each frame,

the estimation calculation section may estimate the estimated pixel values in each frame based on the light-receiving value of the corresponding light-receiving unit and the light-receiving values of the virtual light-receiving units, and

the image output section may calculate a frame image in each frame based on the estimated pixel values, and may synthesize the frame images in the plurality of frames to output the high-resolution frame image.

This makes it possible to estimate the estimated pixel values in each frame based on the light-receiving value of the light-receiving unit that is subjected to the pixel shift process in each frame to calculate the frame images, and synthesize the frame images to output the high-resolution frame image.

In the image processing device,

the image output section may perform a resolution conversion process on the high-resolution frame image to output a High-Vision movie, or may output the high-resolution frame image as a high-resolution still image.

This makes it possible to output a High-Vision movie or a high-resolution still image based on the high-resolution frame image.

Exemplary embodiments of the invention are described in detail below. Note that the following exemplary embodiments do not in any way limit the scope of the invention defined by the claims laid out herein. Note also that all of the elements described in connection with the following exemplary embodiments should not necessarily be taken as essential elements of the invention.

### 1. Comparative Example

A comparative example is described below. A digital camera that is mainly used to shoot a still image may also have a movie shooting function, or a video camera that is mainly used to shoot a movie may also have a still image shooting function. Such a camera is normally designed so that the user selects a still image shooting mode or a movie shooting mode. A camera that allows the user to shoot a high-resolution still image at a high frame rate almost equal to that of a movie has been known. The user can perform high-speed continuous shooting using such a camera. These cameras are convenient to the user since the user can shoot a still image and a movie using a single camera.

However, the above method has a problem in that it is difficult for many users to shoot a high-quality still image without missing the best shot. For example, when using a method that instantaneously changes the shooting mode to a high-quality still image shooting mode when shooting a movie, the movie may be interrupted, or the user may have missed the best moment when the user has become aware that it is possible to take the best shot. Since the above method requires that the user have considerable skill, a method has been desired that allows the user to generate an arbitrary image as a high-resolution image while shooting a movie, or allows the user to extract a high-resolution image from a roughly shot movie, and select the desired composition.

In order to prevent a situation in which the user misses the best shot, each scene may be shot as a movie, and the best moment may be arbitrarily acquired (captured) from the movie as a high-quality still image. When implementing such a method, it is necessary to shoot a high-resolution image at a high frame rate.

However, it is difficult to shoot a high-resolution image at a high frame rate. For example, it is necessary to use an image sensor that can implement ultrafast imaging, a processing circuit that processes image data at an ultrahigh speed, an ultrahigh-speed data compression function, and a recording means that can record a huge amount of data in order to successively shoot 12-megapixel images at a frame rate of 60 frames per second (fps). In this case, it is necessary to employ a plurality of image sensors, parallel processing, a large-capacity memory, a high-performance heat dissipation mechanism, and the like. However, these means are not realistic for consumer products for which a reduction in size and cost is desired. It may be possible to obtain a low-quality still image having a resolution almost equal to that of a High-Vision movie (2 Mpixels). However, a resolution almost equal to that of a High-Vision movie is not sufficient for a still image.

A movie may be shot at a high frame rate by utilizing a high-resolution image sensor that can capture a high-resolution image, and reducing the resolution of the image by performing a pixel thin-out readout process or an adjacent pixel addition readout process to reduce the amount of data read at one time. However, it is impossible to shoot a high-resolution image at a high frame rate using such a method.

In order to solve the above problem, it is necessary to obtain a high-resolution image from low-resolution images that have been shot at a high frame rate. A high-resolution image may be obtained from low-resolution images by performing a super-resolution process on low-resolution images that have been shot while shifting each pixel to generate a high-resolution image, for example.

According to this method, however, a camera having a complex configuration is required since it is necessary to mechanically shift the sensor, or it is necessary to perform an addition readout process while shifting each pixel. Moreover, the processing load increases due to the super-resolution process.

For example, a method that utilizes an addition readout process may be used to implement the super-resolution process that utilizes the pixel shift method. More specifically, a plurality of low-resolution images are sequentially read while performing a position shift process, and a high-resolution image is estimated based on the plurality of low-resolution images that are shifted in position. A low-resolution image is generated by causing the estimated high-resolution image to deteriorate, and is compared with the original low-resolution image. The high-resolution image is modified so that the difference between the generated low-resolution image and the original low-resolution image becomes a minimum to estimate a high-resolution image. The maximum-likelihood (ML) technique, the maximum a posteriori (MAP) technique, the projection onto convex sets (POCS) technique, the iterative back projection (IBP) technique, and the like are known as a technique that implements the super-resolution process.

The method disclosed in JP-A-2009-124621 utilizes the super-resolution process. According to the method disclosed in JP-A-2009-124621, low-resolution images are sequentially shot in time series while shifting each pixel when shooting a movie, and are synthesized to estimate a high-resolution image. The super-resolution process is performed on the estimated high-resolution image to estimate a high-resolution image with high likelihood.

However, the method disclosed in JP-A-2009-124621 utilizes a general super-resolution process that increases the estimation accuracy by repeating calculations that require heavy use of a two-dimensional filter. Therefore, it is difficult to apply the method disclosed in JP-A-2009-124621 to a product that is limited in terms of processing capacity and cost due to an increase in the amount of processing or an increase in processing time. For example, since the scale of a processing circuit necessarily increases when applying the method disclosed in JP-A-2009-124621 to a small portable imaging device such as a digital camera, an increase in power consumption, generation of a large amount of heat, a significant increase in cost, and the like occur.

The method disclosed in JP-A-2008-243037 generates a high-resolution image using a plurality of low-resolution images obtained while shifting each pixel. The method disclosed in JP-A-2008-243037 estimates the pixel value of a sub-pixel (i.e., a pixel of the desired high-resolution image) so that the average value of the pixel values of the sub-pixels coincides with the pixel value of the low-resolution image. The pixel value is estimated by setting the initial value of a plurality of sub-pixels, subtracting the pixel value of each sub-pixel other than the calculation target sub-pixel from the pixel value of the low-resolution image to calculate a pixel value, and sequentially applying the calculated pixel value to the adjacent pixels.

However, the method disclosed in JP-A-2008-243037 has a problem in that an estimation error increases to a large extent when the initial value is not successfully specified. In the method disclosed in JP-A-2008-243037, an area in which a change in pixel value of the sub-pixels is small and the average value of the pixel values of the sub-pixels is almost equal to the pixel value of the pixel of the low-resolution image that covers the sub-pixels is found from the image when setting the initial value. Therefore, it is difficult to estimate the initial value when an area appropriate for setting the initial value cannot be found from the image. Moreover, the method disclosed in JP-A-2008-243037 requires a process that searches for an area appropriate for setting the initial value.

### 2. Light-Receiving Value Interpolation Method

According to several embodiments of the invention, a low-resolution frame image is acquired by an imaging operation, pixel-shifted low-resolution frame images are virtually calculated based on the low-resolution frame image using an interpolation process, and a high-resolution frame image is estimated from the pixel-shifted low-resolution frame images using a simple estimation process.

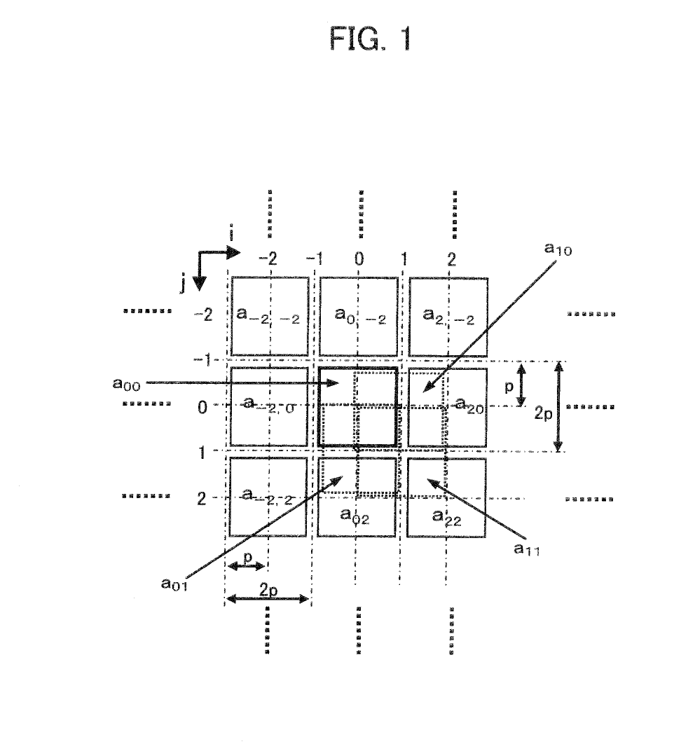

A method that calculates the pixel-shifted low-resolution frame image using the interpolation process is described below with reference to FIG. 1. Note that a light-receiving value (pixel value) acquired by the imaging operation is the light-receiving value of a light-receiving unit (light-receiving value acquisition unit), and a light-receiving value calculated by the interpolation process is the light-receiving value of a virtual light-receiving unit (interpolated light-receiving unit). The following description illustrates an example in which the light-receiving value of the light-receiving unit is a 4-pixel sum value. Note that another configuration may also be employed. For example, the light-receiving value of the light-receiving unit may be the pixel value of one pixel, or may be a 9-pixel sum value.

As illustrated in FIG. 1, light-receiving values a_{-2,-2}, a_{0,-2}, . . . , and a₂₂ (indicated by a square solid line) of light-receiving units that form a low-resolution frame image are acquired by the imaging operation. More specifically, the light-receiving units are set on a four pixel (one pixel or multiple pixel) basis of the image sensor, and the pixel values of the pixels included in each light-receiving unit are summed up or summed up using the weight-adjusted sum, and read to acquire the light-receiving value. When the pixel pitch of the image sensor is referred to as p, the pitch of the light-receiving units is 2p.

Next, three overlap-shifted low-resolution frame images (hereinafter referred to as “shifted images”) are calculated from the low-resolution frame image by performing an intra-frame interpolation process. More specifically, a first shifted image that is shifted by the pitch p in the horizontal direction with respect to the low-resolution frame image, a second shifted image that is shifted by the pitch p in the vertical direction with respect to the low-resolution frame image, and a third shifted image that is shifted by the pitch p in the horizontal direction and the vertical direction with respect to the low-resolution frame image, are calculated. The shift amount corresponds to the shift amount on the image sensor on the assumption that the shifted image is actually captured by the image sensor.

As illustrated in FIG. 1, light-receiving values a₁₀, a₀₁, and a₁₁ (indicated by a square dotted line) of three virtual light-receiving units that are positioned to overlap the acquired light-receiving value a₀₀ respectively form the first to third shifted images. Each virtual light-receiving unit is set on a four pixel basis in the same manner as each light-receiving unit. The light-receiving values a₁₀, a₀₁, and a₁₁ are estimated from the light-receiving values of the light-receiving units positioned around each virtual light-receiving unit. For example, the light-receiving values a₁₀, a₀₁, and a₁₁ are estimated by multiplying the light-receiving values of the light-receiving units positioned around each virtual light-receiving unit by weighting coefficients w₀, w₁, and w₂ (interpolation estimation) (see the following expression (1)).

a₀₀=(known(acquired)value),

a₁₀=(w₁·a_{0,-2}+w₁·a_{2,-2})+(w₀·a₀₀+w₀·a₂₀)+(w₁·a₀₂+w₁·a₂₂),

a₀₁=(w₁·a_{-2,0}+w₁·a_{-2,2})+(w₀·a₀₀+w₀·a₀₂)+(w₁·a₂₀+w₁·a₂₂),

a₁₁=(w₂·a₀₀+w₂·a₂₀+w₂·a₀₂+w₂·a₂₂) (1)

Note that the interpolation process is not limited to the above interpolation process. Various other interpolation processes may also be applied. For example, the weighting coefficients w₀, w₁, and w₂ may be set using the concept of a Bayer interpolation method, a pixel defect correction method, or the like. A high-resolution estimated image may be generated by performing the process shown by the expression (1) on a number of high-resolution image samples while changing the weighting coefficients w₀, w₁, and w₂ to determine weighting coefficients w₀, w₁, and w₂ that minimize the total error in pixel value between the image sample and the estimated image, and the weighting coefficients w₀, w₁, and w₂ thus determined may be used for the estimation process.

### 3. First Estimated Pixel Value Estimation Method

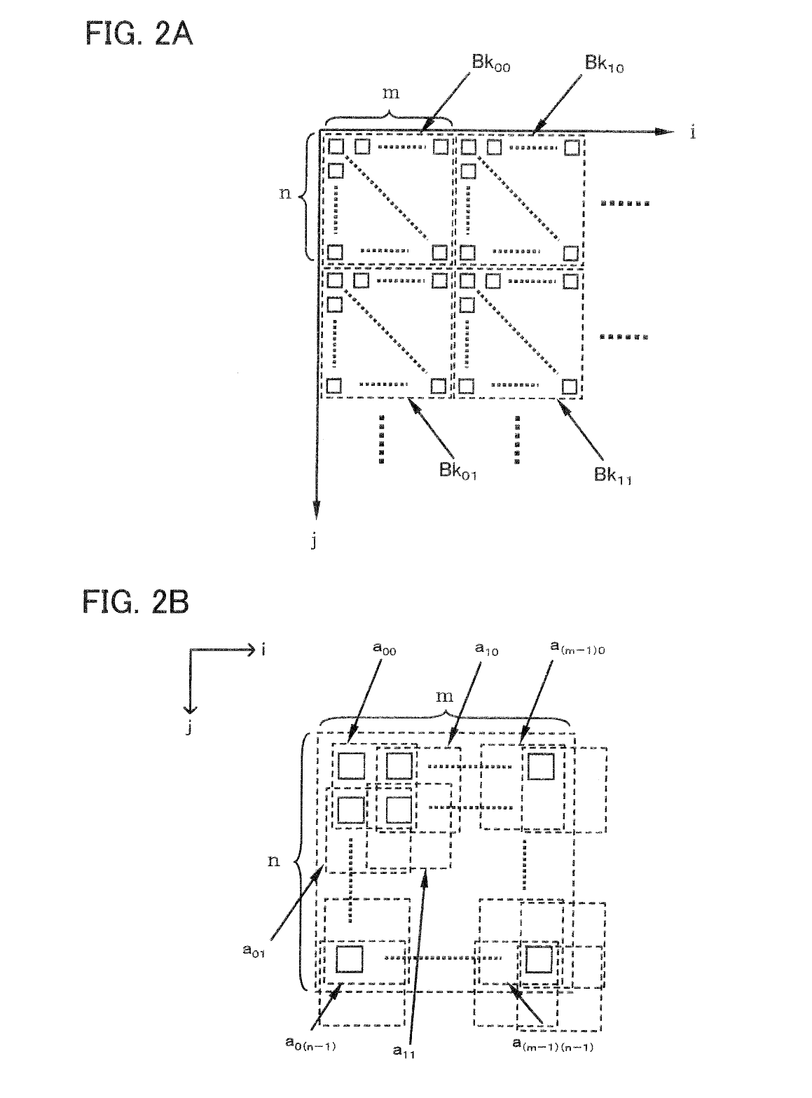

A method that estimates the high-resolution frame image from the low-resolution frame image is described below with reference to FIGS. 2A to 10. In one embodiment of the invention, four low-resolution frame images that are overlap-shifted by the pixel pitch p and include 4-pixel sum values are used to estimate a high-resolution frame image that has a number of pixels four times that of each low-resolution frame image.

FIGS. 2A and 2B are schematic views illustrating an estimation block and a light-receiving unit used for a pixel estimation process. In FIGS. 2A and 2B, each estimated pixel of which the pixel value is calculated by the estimation process is indicated by a square solid line, the pixel position in the horizontal direction (horizontal scan direction) is indicated by i, and the pixel position in the vertical direction is indicated by j (i and j are integers).

As illustrated in FIG. 2A, estimation blocks Bk₀₀, Bk₁₀, . . . are set so that each estimation block includes m×n pixels. In one embodiment of the invention, the pixel values of the high-resolution image are estimated on an estimation block basis. FIG. 2B schematically illustrates one estimation block. The light-receiving values a₀₀ to a₍ₘ₋₁₎₍ₙ₋₁₎ illustrated in FIG. 2B include the light-receiving values of the low-resolution frame image acquired by the imaging operation, and the light-receiving values of the first to third shifted images calculated by the interpolation process.

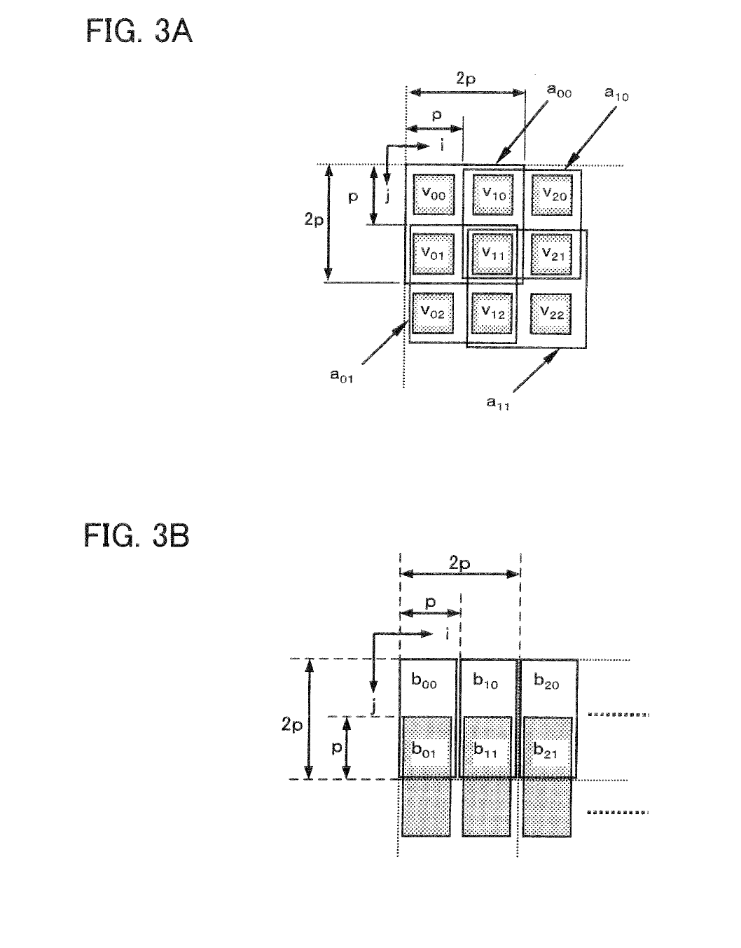

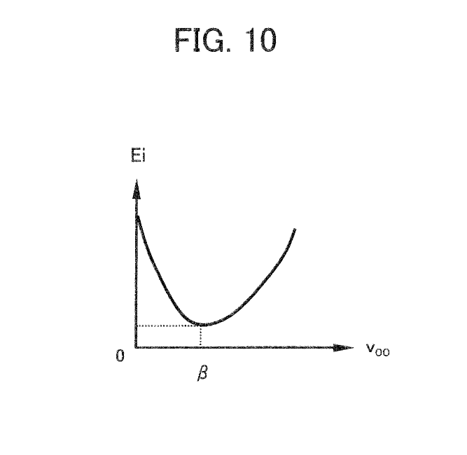

A pixel estimation method according to one embodiment of the invention is described below with reference to FIGS. 3A and 10. An example in which the estimation blocks are set on a 2×2 pixel basis, and each estimated pixel value is estimated from the light-receiving value a₀₀ of one light-receiving unit and the light-receiving values a₁₀, a₀₁, and a₁₁ of three virtual light-receiving units, is described below for convenience of explanation.

FIGS. 3A and 3B are views illustrating an estimated pixel value and an intermediate pixel value. As illustrated in FIG. 3A, estimated pixel values v₀₀ to v₂₂ are estimated using the light-receiving values a₀₀ to a₁₁. Specifically, a high-resolution image that has the same resolution (i.e., the same number of pixels) as that of the image sensor (pixel pitch: p) is estimated from the low-resolution images that include the light-receiving units (pixel pitch: 2p).

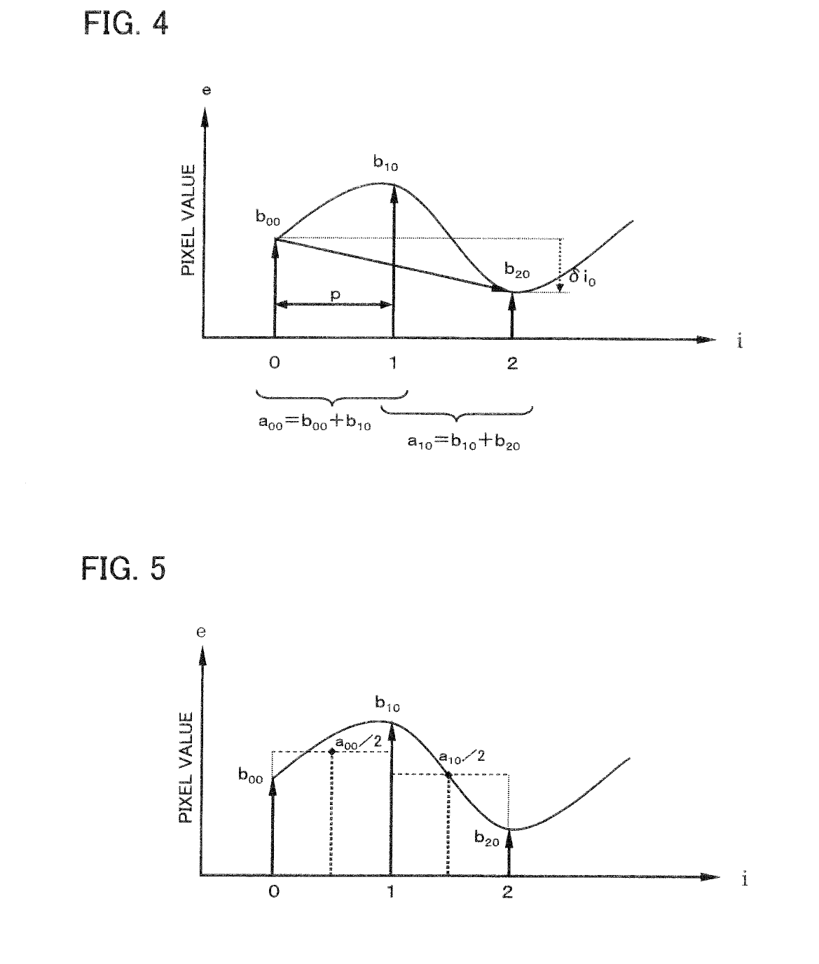

As illustrated in FIG. 3B, intermediate pixel values b₀₀ to b₂₁ (intermediate estimated pixel values or 2-pixel sum values) are estimated from the light-receiving values a₀₀ to a₁₁, and the pixel values v₀₀ to v₂₂ are estimated from the intermediate pixel values b₀₀ to b₂₁. An intermediate pixel value estimation method is described below using the intermediate pixel values b₀₀ to b₂₀ (see FIG. 4) in the first row (i.e., arranged in the horizontal direction) as an example. An example in which the resolution is increased in the horizontal direction to calculate each intermediate pixel value is described below. Note that the resolution may be increased in the vertical direction to calculate each intermediate pixel value.

The light-receiving value and the intermediate pixel value have the relationship shown by the following expression (2) (see FIG. 4).

a₀₀=b₀₀+b₁₀,

a₁₀=b₁₀+b₂₀ (2)

The intermediate pixel values b₁₀ and b₂₀ can be expressed as a function of the intermediate pixel value b₀₀ by transforming the expression (2) where the intermediate pixel value b₀₀ is an unknown (initial variable or initial value) (see the following expression (3)).

b₀₀=(unknown),

b₁₀=a₀₀−b₀₀,

b₂₀=b₀₀+δi₀=b₀₀+(a₁₀−a₀₀) (3)

Note that δi₀ is the difference between the light-receiving values of the light-receiving units that are shifted by one shift, and corresponds to the difference between the intermediate pixel values b₂₀ and b₀₀ (see the following expression (4)).

$$\begin{matrix}δ {i}_{0} = {a}_{10} - {a}_{00} \\ = ( {b}_{10} + {b}_{20} ) - ( {b}_{00} + {b}_{10} ) \\ = {b}_{20} - {b}_{00}\end{matrix} \qquad ( 4 )$$

A high-resolution intermediate pixel value combination pattern {b₀₀, b₁₀, b₂₀} is thus calculated where the intermediate pixel value b₀₀ is an unknown. It is necessary to calculate the unknown (b₀₀) in order to determine the absolute value (value or numerical value) of each intermediate pixel value expressed as a function of the intermediate pixel value b₀₀.

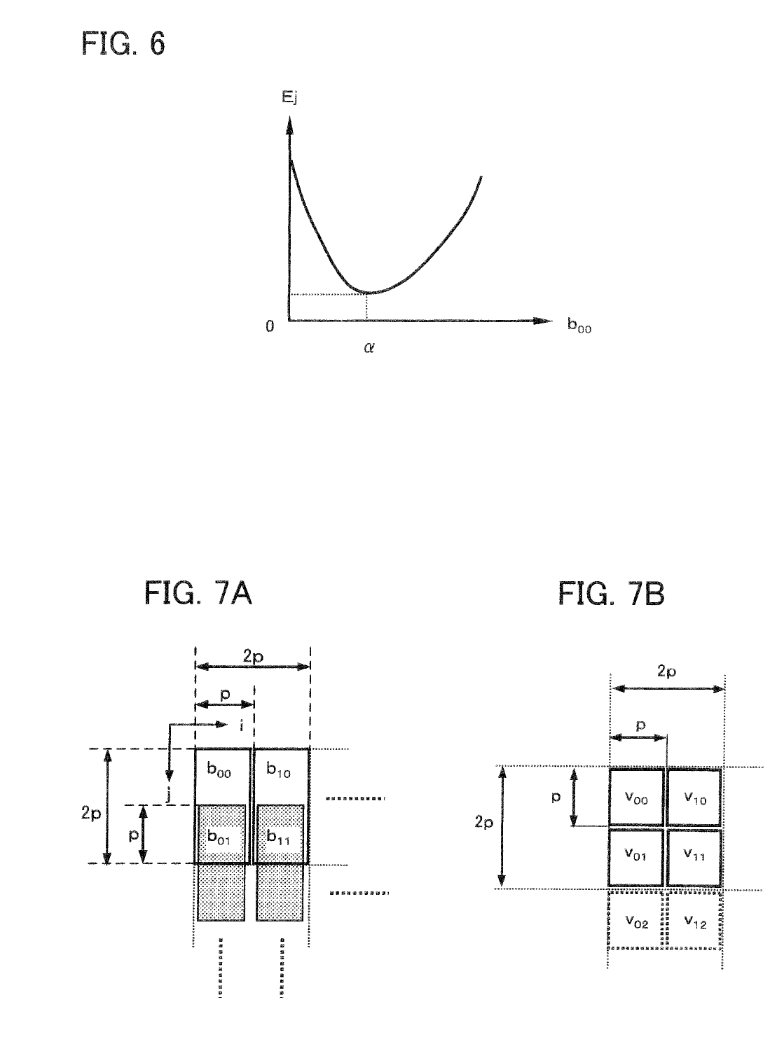

As illustrated in FIG. 5, the light-receiving value pattern {a₀₀, a₁₀} is compared with the intermediate pixel value pattern {b₀₀, b₀₁, b₂₀}. An unknown (b₀₀) that minimizes an error between the light-receiving value pattern {a₀₀, a₁₀} and the intermediate pixel value pattern {b₀₀, b₁₀, b₂₀} is derived, and set as the intermediate pixel value b₀₀. More specifically, an error evaluation function Ej is expressed as a function of the unknown (b₀₀) (see the following expression (5)). As illustrated in FIG. 6, an unknown α (=b₀₀) (initial value) at which the value of the evaluation function Ej becomes a minimum (minimum value) is calculated by a search process (least-square method).

$${e}_{ij} = {( \frac{{a}_{ij}}{2} - {b}_{ij} )}^{2} + {( \frac{{a}_{ij}}{2} - {b}_{( i + 1 ) j} )}^{2} , \\ Ej = {\sum }_{i = 0}^{1} {e}_{ij} \qquad ( 5 )$$

In one embodiment of the invention, an error between the average value of the intermediate pixel values and the pattern {a₀₀, a₁₀} containing a low-frequency component is evaluated (see the expression (5)). This makes it possible to prevent a situation in which a pattern that contains a large amount of high-frequency components is derived as an estimated solution of the intermediate pixel values {b₀₀, b₁₀, b₂₀}. More specifically, an image that contains a large amount of low-frequency components is generated even if the unknown is estimated incorrectly. Therefore, it is possible to prevent a situation in which a pattern is generated so that a high-frequency component that tends to produce unnaturalness as compared with a low-frequency component contains an error, so that a natural image can be obtained. A reasonable pixel estimation process can thus be performed on a natural image that contains a small amount of high-frequency components as compared with low-frequency components.

The intermediate pixel value b₀₀ thus estimated is substituted into the expression (3) to determine the intermediate pixel values b₁₀ and b₂₀. The intermediate pixel values b₀₁ to b₂₁ in the second row are similarly estimated where the intermediate pixel value b₀₁ is an unknown.

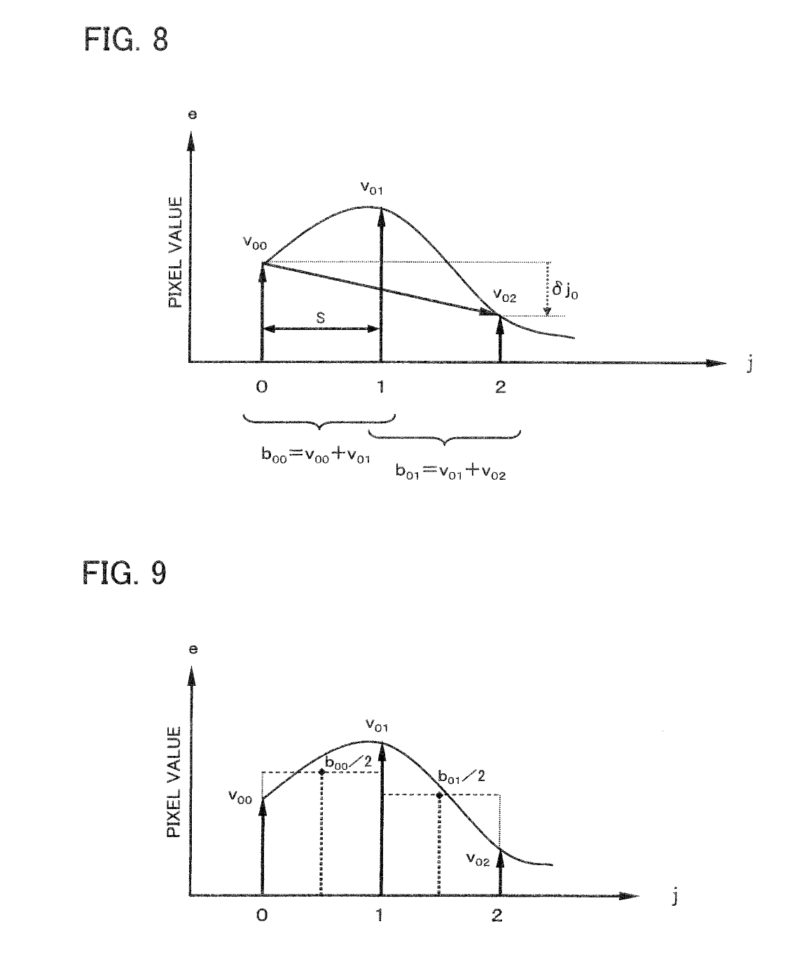

The estimated pixel values vᵢⱼ are calculated as described below using the estimated intermediate pixel values bᵢⱼ. FIGS. 7A and 7B are views schematically illustrating the intermediate pixel value and the estimated pixel value. As illustrated in FIG. 7A, an estimation process is performed using the intermediate pixel values b₀₀ to b₁₁ (two columns) among the intermediate pixel values b₀₀ to b₂₁ (three columns) estimated by the above method. As illustrated in FIG. 7B, the pixel values v₀₀ to v₁₂ are estimated from the intermediate pixel values b₀₀ to b₁₁. The following description is given taking the pixel values v₀₀ to v₀₂ in the first column (see FIG. 8) as an example for convenience of explanation.

The pixel values v₀₀ to v₀₂ are estimated by a method similar to the intermediate pixel value estimation method. More specifically, the intermediate pixel values b₀₀ and b₀₁ are equal to values obtained by overlap-sampling the pixel values v₀₀ to v₀₂ on a two-pixel basis in the vertical direction. Therefore, the intermediate pixel values and the estimated pixel values have the relationship shown by the following expression (6).

b₀₀=v₀₀+v₀₁,

b₀₁=v₀₁+v₀₂ (6)

The pixel values v₀₁ and v₀₂ can be expressed as a function of an unknown (v₀₀) (see the following expression (7)).

v₀₀=(unknown),

v₀₁=b₀₀−v₀₀,

v₀₂=v₀₀+δj₀=v₀₀+(b₀₁−b₀₀) (7)

Note that δj₀ is the difference between the intermediate pixel values that are shifted by one shift, and corresponds to the difference between the pixel values v₀₂ and v₀₀ (see the following expression (8)).

$$\begin{matrix}δ {i}_{0} = {b}_{01} - {b}_{00} \\ = ( {v}_{01} + {v}_{02} ) - ( {v}_{00} + {v}_{01} ) \\ = {v}_{02} - {v}_{00}\end{matrix} \qquad ( 8 )$$

As illustrated in FIG. 9, the unknown (v₀₀) is derived so that an error between the intermediate pixel value pattern {b₀₀, b,o} and the estimated pixel value pattern {v₀₀, v₀₁, v₀₂} becomes a minimum. Specifically, an unknown β (=v₀₀) at which the value of an error evaluation function Ei (see the following expression (9)) becomes a minimum (see FIG. 10) is calculated by a search process.

$${e}_{ij} = {( \frac{{b}_{ij}}{2} - {v}_{ij} )}^{2} + {( \frac{{b}_{ij}}{2} - {v}_{i ( j + 1 )} )}^{2} , \\ Ei = {\sum }_{j = 0}^{1} {e}_{ij} \qquad ( 9 )$$

The pixel values v₁₀ to v₁₂ in the second column are calculated in the same manner as described above to determine the final estimated pixel values v₀₀, v₀₁, v₁₀, and v₁₁. Note that an appropriate noise reduction process may be performed on the image data having the final estimated pixel values to obtain a display image. The final estimated pixel values v₀₀, v₀₁, v₁₀, and v₁₁ need not necessarily be calculated at one time. For example, the final estimated pixel values (e.g., v₀₀) may be sequentially calculated on a pixel basis while shifting the estimation block unit in the horizontal direction or the vertical direction.

Although an example in which the unknown (b₀₀ or v₀₀) is calculated by a search process has been described above, the unknown (b₀₀ or v₀₀) may be calculated directly. Specifically, the expression (5) (i.e., a quadratic function formula of the unknown (b₀₀)) that indicates the evaluation function Ej can be transformed into the following expression (10). Therefore, the minimum value a of the unknown (b₀₀) at which the value of the evaluation function Ej becomes a minimum can be calculated directly. The minimum value β of the unknown (v₀₀) can also be similarly calculated.

Ej=(b₀₀−α)²+ξ (10)

A method that allows the user to select the still image shooting mode or the movie shooting mode has a problem in that it is difficult for the user to take the best shot (best moment). A method that increases the resolution using the super-resolution process has a problem in that the scale of the processing circuit necessarily increases in order to deal with high processing load, for example. A method that uses the pixel shift process has a problem in that a camera having a complex configuration is required since it is necessary to mechanically shift the optical system, and perform a shift readout process.

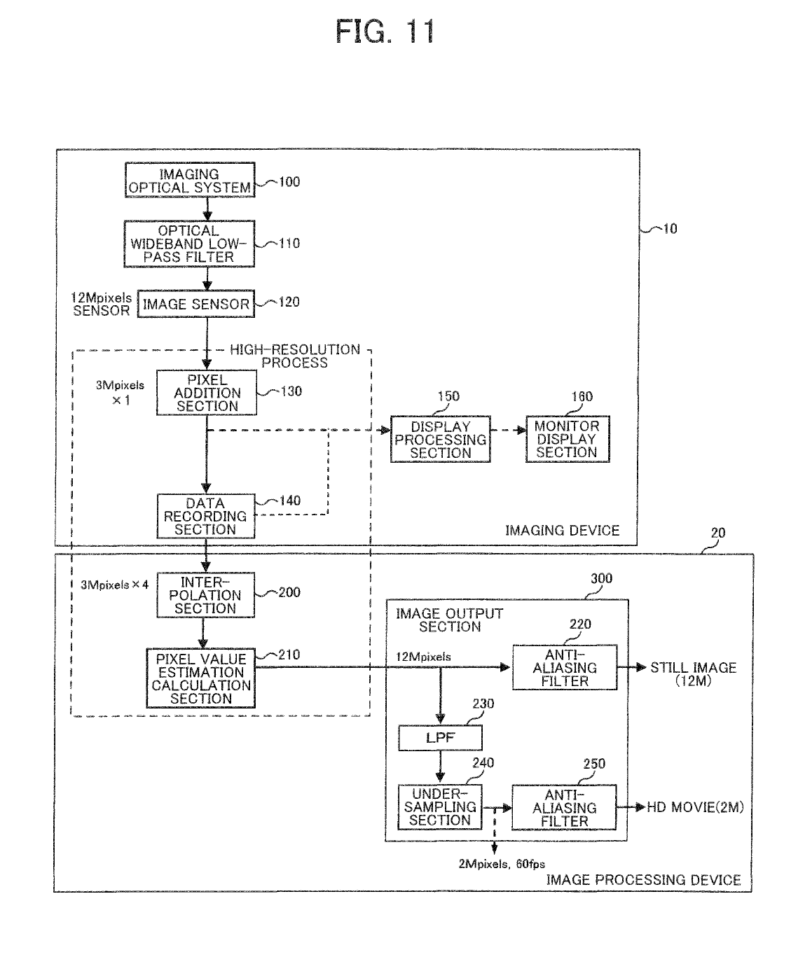

According to one embodiment of the invention, the light-receiving units that respectively acquire the light-receiving values a_{-2,-2}, a_{0,-2}, . . . , and a₂₂ are set to the image sensor (e.g., image sensor 120 illustrated in FIG. 11), and the light-receiving values a_{-2,-2}, a_{0,-2}, . . . , and a₂₂ of the light-receiving units are read to acquire a low-resolution frame image (see FIG. 1). The low-resolution frame image is stored in a storage section (e.g., data recording section 140 illustrated in FIG. 11). An interpolation section (interpolation section 200) calculates the light-receiving values a₁₀, a₀₁, and a₁₁ of the virtual light-receiving units by the interpolation process based on the light-receiving values a_{-2,-2}, a_{0,-2}, . . . , and a₂₂ of the light-receiving units, the virtual light-receiving units being set to overlap the light-receiving unit that acquires the light-receiving value a₀₀ at a position shifted from the position of the light-receiving unit that acquires the light-receiving value a₀₀. An estimation calculation section (pixel value estimation calculation section 210) estimates the estimated pixel values v₀₀ to v₁₁ at the pixel pitch p smaller than the pixel pitch 2p of the low-resolution frame image based on the light-receiving value a₀₀ of the light-receiving unit and the light-receiving values a₁₀, a₀₁, and a₁₁ of the virtual light-receiving units (see FIG. 3A, for example). An image output section (image output section 300) outputs a high-resolution frame image having a resolution higher than that of the low-resolution frame image based on the estimated pixel values v₀₀ to v₁₁.

The position of the light-receiving unit refers to the position or the coordinates of the light-receiving unit in the light-receiving plane of the image sensor, or the position or the coordinates of the light-receiving unit indicated by estimated pixel value data (image data) used for the estimation process. The expression “position (coordinates) shifted from . . . ” refers to a position (coordinates) that does not coincide with the original position (coordinates). The expression “virtual light-receiving unit overlaps the light-receiving unit” means that the light-receiving unit and the virtual light-receiving unit have an overlapping area. For example, the expression “virtual light-receiving unit overlaps the light-receiving unit” means that the light-receiving unit a₀₀ and the virtual light-receiving unit a₁₀ share two estimated pixels v₁₀ and v₁₁ (see FIG. 3A).

The above configuration makes it possible to acquire a high-resolution image from a movie using a simple process, or increase the resolution of an image without performing a pixel shift process. For example, the estimation process can be simplified by utilizing the intermediate pixel value estimation process. Since a high-resolution still image at an arbitrary timing of the low-resolution movie can be generated, the user can easily obtain a high-resolution still image at the best moment. Moreover, a low-resolution movie (e.g., 3 Mpixels) can be shot at a high frame rate, and a high-resolution still image (12 Mpixels) or the like can arbitrarily be displayed.

The estimation calculation section may calculate the difference δi₀ (=a₁₀−a₀₀) between the light-receiving value a₀₀ of a first light-receiving unit that is set at a first position and the light-receiving value a₁₀ of a second light-receiving unit that is set at a second position and overlaps the first light-receiving unit (see FIG. 3A). The estimation calculation section may estimate the estimated pixel values v₀₀to v₁₁ (i.e., the estimated pixel values in the estimating block) based on the difference δi₀. The first light-receiving unit is either the light-receiving unit or the virtual light-receiving unit. Specifically, the first light-receiving unit and the second light-receiving unit may respectively be the light-receiving unit and the virtual light-receiving unit, or both the first light-receiving unit and the second light-receiving unit may be the virtual light-receiving units.

The resolution can be increased using a simple process by thus estimating the estimated pixel values v₀₀ to v₁₁ based on the difference δi₀ between the light-receiving values a₁₀ and a₀₀ of the light-receiving units that overlap each other.

As illustrated in FIGS. 3A and 3B, a first intermediate pixel value b₀₀ may be the light-receiving value of a first light-receiving area (i.e., an area that includes the estimated pixel values v₀₀ and vo₀₁) obtained by removing an overlapping area (i.e., an area that includes the estimated pixel values v₁₀ and v₁₁) from the first light-receiving unit that acquires the light-receiving value a₀₀. A second intermediate pixel value b₂₀ may be the light-receiving value of a second light-receiving area (i.e., an area that includes the estimated pixel values v₂₀ and v₂₁) obtained by removing an overlapping area from the second light-receiving unit that acquires the light-receiving value a₁₀. The estimation calculation section may express a relational expression of the first intermediate pixel value b₀₀ and the second intermediate pixel value b₂₀ using the difference δi₀ (see the expression (3)), and may estimate the first intermediate pixel value b₀₀ and the second intermediate pixel value b₂₀ using the relational expression. The estimation calculation section may calculate the estimated pixel values v₀₀ to v₁₁ using the first intermediate pixel value b₀₀ (see FIGS. 7A and 7B).

The high-resolution image estimation process can be simplified by estimating the intermediate pixel values from the light-receiving values obtained by overlap shift sampling, and calculating the estimated pixel values from the intermediate pixel values. For example, a complex process (e.g., repeated calculations using a two-dimensional filter (JP-A-2009-124621) or a process that searches for an area appropriate for setting the initial value (JP-A-2008-243037)) employed in the comparative example can be made unnecessary.

In one embodiment of the invention, when an intermediate pixel value pattern includes consecutive intermediate pixel values {b₀₀, b₁₀, b₂₀} that include the first intermediate pixel value b₀₀ and the second intermediate pixel value b₂₀ (see FIG. 3B), the estimation calculation section may express a relational expression of the intermediate pixel values included in the intermediate pixel value pattern {b₀₀, b₀₁, b₂₀}using the light-receiving values a₀₀ and a₁₀ (see the expression (3)). The estimation calculation section may compare the intermediate pixel value pattern {b₀₀, b₀₀, b₂₀}expressed by the relational expression and the light-receiving value pattern {a₀₀, a₁₀}expressed by the light-receiving values a₀₀ and a₁₀ to evaluate similarity, and may determine the intermediate pixel values b₀₀ to b₂₀ included in the intermediate pixel value pattern so that the similarity becomes a maximum based on the similarity evaluation result (see FIG. 5).

Note that the intermediate pixel value pattern is a data string (data set) of intermediate pixel values within a range used for the estimation process. The light-receiving value pattern is a data string of light-receiving values within a range used for the estimation process (i.e., a data string that includes the light-receiving value of the light-receiving unit and the light-receiving value of the virtual light-receiving unit).

The above configuration makes it possible to estimate the intermediate pixel values b₀₀ to b₂₀ based on the light-receiving value a₀₀ of the light-receiving unit, and the light-receiving value a₁₀ of the virtual light-receiving unit calculated by the interpolation process using the light-receiving value of the light-receiving unit. It is also possible to estimate a high-resolution intermediate pixel value pattern similar to the light-receiving value pattern by comparing the intermediate pixel value pattern {b₀₀, b₁₀, b₂₀} and the light-receiving value pattern {a₀₀, a₁₀}.

The estimation calculation section may calculate the evaluation function Ej that indicates an error between the intermediate pixel value pattern {b₀₀, b₁₀, b₂₀} and the light-receiving value pattern {a₀₀, a₁₀}(see the expression (5)), may calculate the unknown α (=b₀₀) (initial value) at which the value of the evaluation function Ej becomes a minimum, and may determine the intermediate pixel values b₀₀ to b₂₀ using the calculated unknown (b₀₀).

The intermediate pixel values can thus be estimated by expressing the error using the evaluation function, and calculating the intermediate pixel value that corresponds to the minimum value of the evaluation function. For example, the initial value used for the intermediate pixel value estimation process can be set using a simple process by calculating the unknown using the least-square method. Specifically, it is unnecessary to search for an image area appropriate for setting the initial value, differing from the comparative example (JP-A-2008-243037).

The interpolation section may calculate the weighted sum of the light-receiving values (among the light-receiving values a_{-2,-2}, a_{0,-2}, . . . , and a₂₂) of a plurality of light-receiving units included in the low-resolution frame image that are positioned around each virtual light-receiving unit to calculate the light-receiving values a₁₀, a₀₁, and a₁₁ of the virtual light-receiving units (see FIG. 1).

The plurality of light-receiving units positioned around each virtual light-receiving unit include at least a light-receiving unit that overlaps each virtual light-receiving unit (e.g., the light-receiving units a₀₀ and a₂₀ that overlap the virtual light-receiving unit a₁₀). The plurality of light-receiving units positioned around each virtual light-receiving unit may include a light-receiving unit that overlaps each virtual light-receiving unit and a light-receiving unit adjacent to the light-receiving unit that overlaps each virtual light-receiving unit (e.g., the light-receiving units a₀₀ and a₂₀ that overlap the virtual light-receiving unit a₁₀, and the light-receiving unit a_{0,-2}, a_{2,-2}, a₀₂, and a₂₂ adjacent to the light-receiving units a₀₀ and a₂₀).

This makes it possible to calculate the light-receiving values a₁₀, a₀₁, and a₁₁ of the virtual light-receiving units that are set to overlap the light-receiving unit a₀₀ by performing the interpolation process based on the light-receiving values a_{-2,-2}, a_{0,-2}, . . . , and a₂₂ of the light-receiving units.

### 4. First Configuration Example of Imaging Device and Image Processing Device

FIG. 11 illustrates a first configuration example of an imaging device and an image processing device that implement the interpolation process and the estimation process. An imaging device 10 illustrated in FIG. 11 includes an imaging optical system 100 (lens), an optical low-pass filter 110 (optical wideband low-pass filter), an image sensor 120 (imaging section), a pixel addition section 130 (readout control section), a data recording section 140 (storage section), a display processing section 150 (display control section), and a monitor display section 160 (display device). An image processing device 20 illustrated in FIG. 11 includes an interpolation section 200 (overlap-shift/pixel-sum-up low-resolution image interpolation calculation section), a pixel value estimation calculation section 210 (high-resolution image pixel value estimation calculation section or estimation section), and an image output section 300.

Note that the configuration of the imaging device and the image processing device according to one embodiment of the invention is not limited to the configuration illustrated in FIG. 11. Various modifications may be made, such as omitting some of the elements or adding other elements. Although FIG. 11 illustrates an example in which the image processing device 20 is provided outside the imaging device 10, the image processing device 20 may be provided in the imaging device 10.

The imaging device 10 is a digital camera or a video camera, for example. The imaging optical system 100 forms an image of an object. The optical wideband low-pass filter 110 allows light within a band that corresponds to the resolution of the image sensor 120 to pass through, for example. The image sensor 120 (e.g., 12 Mpixels) is a CCD sensor or a CMOS sensor that implements an analog addition readout process, for example. The pixel addition section 130 controls the light-receiving unit setting process and the addition readout process, and acquires a low-resolution frame image (e.g., 3 Mpixels (one image/frame)), for example. The data recording section 140 is implemented by a memory card or the like, and records a movie formed by the low-resolution frame images. The monitor display section 160 displays a live-view movie, or displays a movie that is being played.

The image processing device 20 is implemented by an image processing engine (IC) or a computer (PC), for example. The interpolation section 200 interpolates the light-receiving values of the low-resolution frame image to calculate shifted images (e.g., 3 Mpixels (four images/frame)). The pixel value estimation calculation section 210 estimates the final estimated pixel values. The image output section 300 includes anti-aliasing filters 220 and 250, a low-pass filter 230, and an under-sampling section 240, and outputs a still image or a movie using the final estimated pixel values. The anti-aliasing filter 220 performs an anti-aliasing process on the final estimated pixel values, and outputs a high-resolution still image (e.g., 12 Mpixels). The low-pass filter 230 limits the final estimated pixel values to the High-Vision band. The under-sampling section 240 under-samples the band-limited final estimated pixel values to the number of pixels used for a High-Vision movie. The anti-aliasing filter 220 performs an anti-aliasing process on the under-sampled image, and outputs a High-Vision movie (e.g., 2 Mpixels). Note that a high-resolution movie (e.g., 12 Mpixels) may be output without performing the under-sampling process.

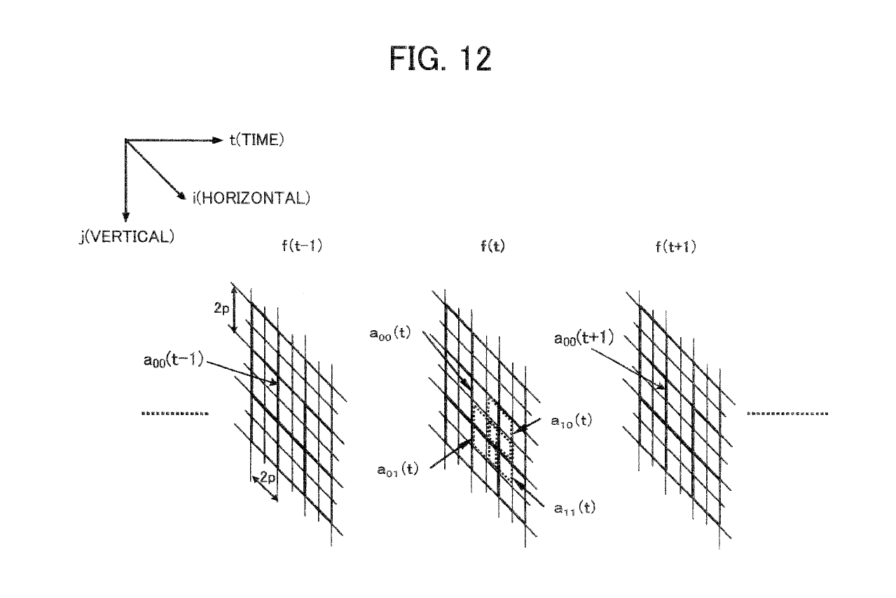

FIG. 12 is a view illustrating the interpolation method employed when shooting a movie. As illustrated in FIG. 12, a low-resolution frame image is acquired every frame using the addition readout process when shooting a movie. For example, light-receiving values a₀₀(t−1), a₀₀(t), and a₀₀(t+1) are acquired in frames f(t−1), f(t), and f(t+1), respectively. When generating a high-resolution still image in the frame f(t), the interpolation process is performed on the low-resolution frame image in the frame f(t) to calculate light-receiving values a₁₀(t), a₀₁(t), and a₁₁(t) of virtual light-receiving units in the frame f(t). A high-resolution still image is estimated from these light-receiving values. The interpolation process is not performed on the low-resolution frame images in the frames f(t−1) and f(t+1) that are not used to generate a still image.

Note that the term “frame” used herein refers to a timing at which one low-resolution frame image is captured by an image sensor, or a timing at which one low-resolution frame image is processed by image processing, for example. A low-resolution frame image or a high-resolution frame image included in image data may also be appropriately referred to as “frame”.

According to the above configuration example, the image output section 300 performs the resolution conversion process on the high-resolution frame image (12 Mpixels) to output a High-Vision movie (2 Mpixels), or outputs the high-resolution frame image (12 Mpixels) as a high-resolution still image (12 Mpixels).

This makes it possible to shoot a low-resolution movie at a high frame rate, and output a high-resolution still image at an arbitrary timing from the movie. Specifically, the user can select the desired timing and the desired composition while playing a High-Vision movie to obtain a high-resolution still image. Note that the high-resolution still image or the High-Vision movie are output to a display section, a memory, a printer, or the like (not illustrated in FIG. 1). When the image processing device 20 is included in the imaging device 10, the high-resolution still image or the High-Vision movie may be displayed on the monitor display section 160.

### 5. Second Estimated Pixel Value Estimation Method (Color)

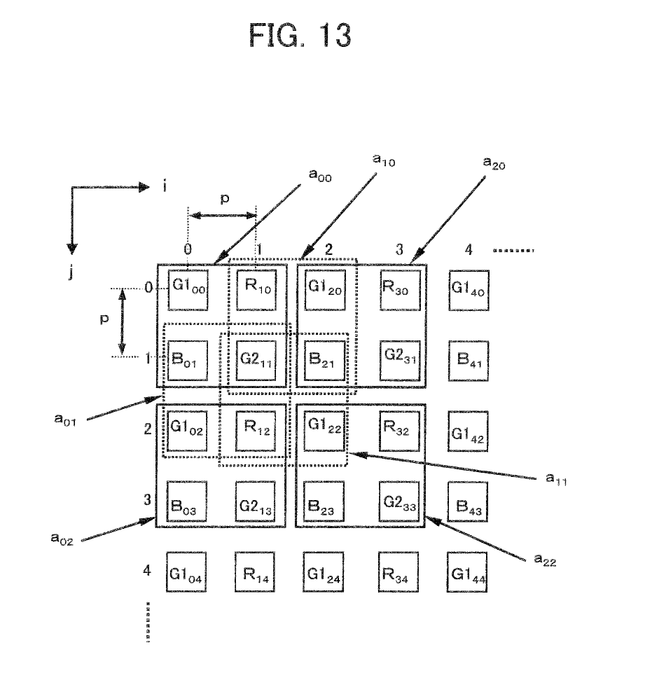

Although an example in which the pixel values of a monochromatic image are estimated has been described above, the embodiments of the invention may also be applied when estimating the pixel values of a color image. A second estimated pixel value estimation method that estimates the pixel values of a color image is described below with reference to FIG. 13.

The second color image estimation method performs the addition readout process without distinguishing RGB to estimate the final RGB pixel values. More specifically, the light-receiving values a₀₀, a₂₀, and the like are acquired by the imaging operation (see FIG. 11). The light-receiving values a₁₀, a₀₁, a₁₁, and the like are calculated by the interpolation process. For example, the light-receiving values a₀₀, a₁₀, a₀₁, and a₁₁ are shown by the following expression (11)

a₀₀=R₁₀+G1₀₀+G2₁₁+B₀₁,

a₁₀=R₁₀+G1₂₀+G2₁₁+B₂₁,

a₀₁=R₁₂+G1₀₂+G2₁₁+B₀₁,

a₁₁=R₁₂+G1₂₂+G2₁₁+B₂₁ (11)

The pixel values v₀₀, v₁₀, v₀₁, and v₁₁ are estimated based on these light-receiving values using the above estimation process (see FIG. 3A, for example). Since the relationship between the estimated pixel values and RGB is known, the RGB estimated pixel values G1₀₀=v₀₀, R₁₀=v₁₀, B₀₁=v₀₁, and G2₁₁=v₁₁ can be calculated.

According to the above estimation method, the image sensor may be a color image sensor (RGB image sensor), and a plurality of adjacent pixels G1₀₀, R₁₀, B₀₁, and G2₁₁ may be set as the light-receiving unit independently of the color of each pixel. The pixel values of the plurality of pixels set as the light-receiving unit are summed up, and read (a₀₀=G1₀₀+R₁₀+B₀₁+G2₁₁) to acquire a low-resolution frame image. The pixel values G1₀₀, R₁₀, B₀₁, and G2₁₁ of the pixels of the light-receiving unit are estimated based on the light-receiving value a₀₀ acquired by the imaging operation and the light-receiving values a₁₀, a₀₁, and a₁₁ calculated by the interpolation process, and a high-resolution color frame image is output based on the estimated pixel values.

This makes it possible to shoot a low-resolution color frame image at a high frame rate, and estimate the pixel values from the low-resolution frame image to acquire a high-resolution color frame image at an arbitrary timing. Since the light-receiving value is acquired by summing up the pixel values of four adjacent pixels, random noise can be reduced. Since it is unnecessary to distinguish the colors of the pixels so that the readout pixels are positioned close to each other, a high-resolution estimation process can be implemented as compared with the case of using the light-receiving units on a color basis.

### 6. Third Estimated Pixel Value Estimation Method

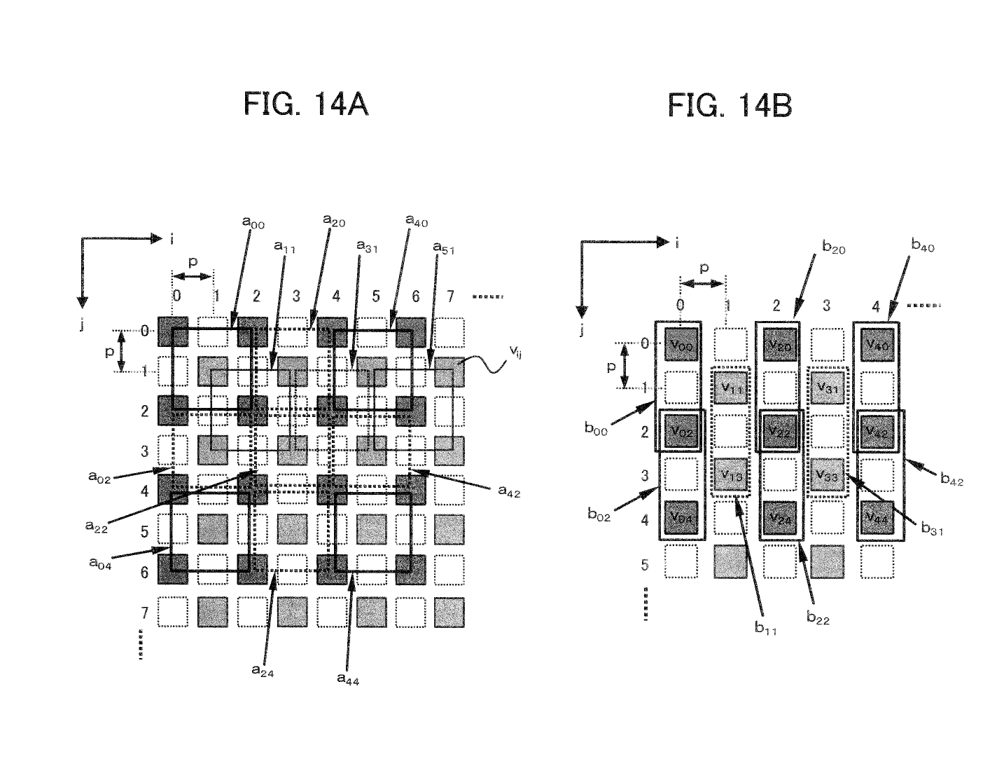

The addition readout process may be performed on an RGB basis to estimate the final RGB pixel values. A third estimated pixel value estimation method that performs the addition readout process on an RGB basis is described below with reference to FIGS. 14A to 17.

The G pixel value is estimated as described bellow. As illustrated in FIG. 14A, the 4-pixel sum values {a₀₀, a₄₀, . . . } of the G1 pixels and the 4-pixel sum values {a₁₁, a₅₁, . . . } of the G2 pixels are sampled as the light-receiving values of the light-receiving units. In FIG. 14A, the G1 pixels are indicated by a dark hatched square, the G2 pixels are indicated by a light hatched square, the light-receiving units are indicated by a solid line, and the virtual light-receiving units are indicated by a dotted line. The light-receiving values {a₂₀, . . . , a₀₂, a₂₂, . . . } of the G1 virtual light-receiving units and the light-receiving values {a₃₁, . . . , a₁₃, a₃₃, . . . } of the G2 virtual light-receiving units are calculated from the acquired light-receiving values by performing an interpolation process. The interpolation process may be separately performed on the G1 pixels and the G2 pixels using the above interpolation method, or may be performed by a common interpolation method using the light-receiving values of the G pixels and the light-receiving values of the G2 pixels. For example, the light-receiving value a₂₀ is calculated by calculating the average value of the light-receiving values a₀₀ and a₄₀.

The final pixel values vᵢⱼ of the G pixels are estimated from these light-receiving values. More specifically, the final pixel values vᵢⱼ of the G pixels are estimated from the following first group G1 (i.e., the 4-pixel sum values of the G1 pixels) and the following second group G2 (i.e., the 4-pixel sum values of the G2 pixels). Note that L is an integer equal to or larger than 0.

First group G1: {a₀₀, a₂₀, a₄₀, . . . , a_{(2L)(2L)}, . . . }
Second group G2: {a₁₁, a₃₁, a₅₁, . . . , a_{(2L+1)(2L+1)}, . . . }

FIG. 14B is a view illustrating the intermediate pixels and the estimated pixels. As illustrated in FIG. 14B, the intermediate pixel values {b₀₀, b₂₀, b₄₀, . . . } of the G1 pixels and the intermediate pixel values {b₁₁, b₃₁, . . . } of the G2 pixels are estimated. Each intermediate pixel is set to overlap the next intermediate pixel in the vertical direction. The estimated pixel values {v₀₀, v₂₀, v₄₀, . . . } of the G1 pixels and the estimated pixel values {v₁₁, v₃₁, . . . } of the G2 pixels are estimated from the intermediate pixel values.

The intermediate pixel values are estimated as described below. The following description focuses on the intermediate pixel values of the G1 pixels. Note that the intermediate pixel values of the G2 pixels can be estimated in the same manner as the intermediate pixel values of the G1 pixels. When the 4-pixel sum values (pixel values) aᵢⱼ in the first row (arranged in the horizontal direction) are referred to as a₀₀, a₂₀, and a₄₀ in the shift order (see FIG. 15), the following expression (12) is satisfied.

a₀₀=b₀₀+b₂₀,

a₂₀=b₂₀+b₄₀ (12)

The intermediate pixel values b₂₀ and b₄₀ can be calculated as a function of the intermediate pixel value b₀₀ where the intermediate pixel value b₀₀ is an unknown (initial variable) (see the following expression (13)).

b₀₀=(unknown),

b₂₀=a₀₀−b₀₀,

b₄₀=b₀₀+δi₀=b₀₀+(a₂₀−a₀₀) (13)

Note that δi₀ is the difference between the light-receiving values shifted by one shift, and is shown by the following expression (14).

$$\begin{matrix}δ {i}_{0} = {a}_{20} - {a}_{00} \\ = ( {b}_{00} + {b}_{20} ) - ( {b}_{20} + {b}_{40} ) \\ = {b}_{40} - {b}_{00}\end{matrix} \qquad ( 14 )$$

The intermediate pixel value pattern {b₀₀, b₂₀, b₄₀} is compared with the 4-pixel sum value pattern {a₀₀, a₁₁, a₂₀}(see the FIG. 15), and an unknown (b₀₀) at which an error between the intermediate pixel value pattern {b₀₀, b₂₀, b₄₀} and the 4-pixel sum value pattern {a₀₀, a₁, a₂₀} becomes a minimum is derived, and set as the intermediate pixel value b₀₀. The 4-pixel sum value pattern {a₀₀, a₁₁, a₂₀} is a light-receiving value pattern obtained by combining the light-receiving values included in the first group G1 and the second group G2. More specifically, an evaluation function eᵢⱼ shown by the following expression (15) is calculated as an error evaluation function, and an unknown (b₀₀) at which the value of the evaluation function eₒₒ becomes a minimum is calculated. The intermediate pixel values b₂₀ and b₄₀ are calculated by the expression (13) using the calculated intermediate pixel value b₀₀. The intermediate pixel values {b₀₂, b₂₂, b₄₂} and the like can be calculated by applying the above method.

$${e}_{ij} = {( \frac{{a}_{ij}}{2} - {b}_{ij} )}^{2} + {( \frac{{a}_{( i + 1 ) ( j + 1 )}}{2} - {b}_{( i + 2 ) j} )}^{2} + {( \frac{{a}_{( i + 2 ) j}}{2} - {b}_{( i + 4 ) j} )}^{2} \qquad ( 15 )$$

It is likely that the method that compares the intermediate pixel value pattern with the light-receiving value pattern obtained by combining the light-receiving values included in the first group G1 and the second group G2 can easily estimate a higher spatial frequency component as compared with a method that compares the intermediate pixel value pattern with the light-receiving value pattern that includes only the light-receiving values included in the first group G1. Note that the light-receiving value pattern {a₀₀, a₂₀} that includes only the light-receiving values included in the first group G1 may be compared with the intermediate pixel value pattern {b₀₀, b₂₀, b₃₀}. It is desirable to appropriately select the 4-pixel sum values to be compared with the intermediate pixel value pattern so that the estimation accuracy is improved.

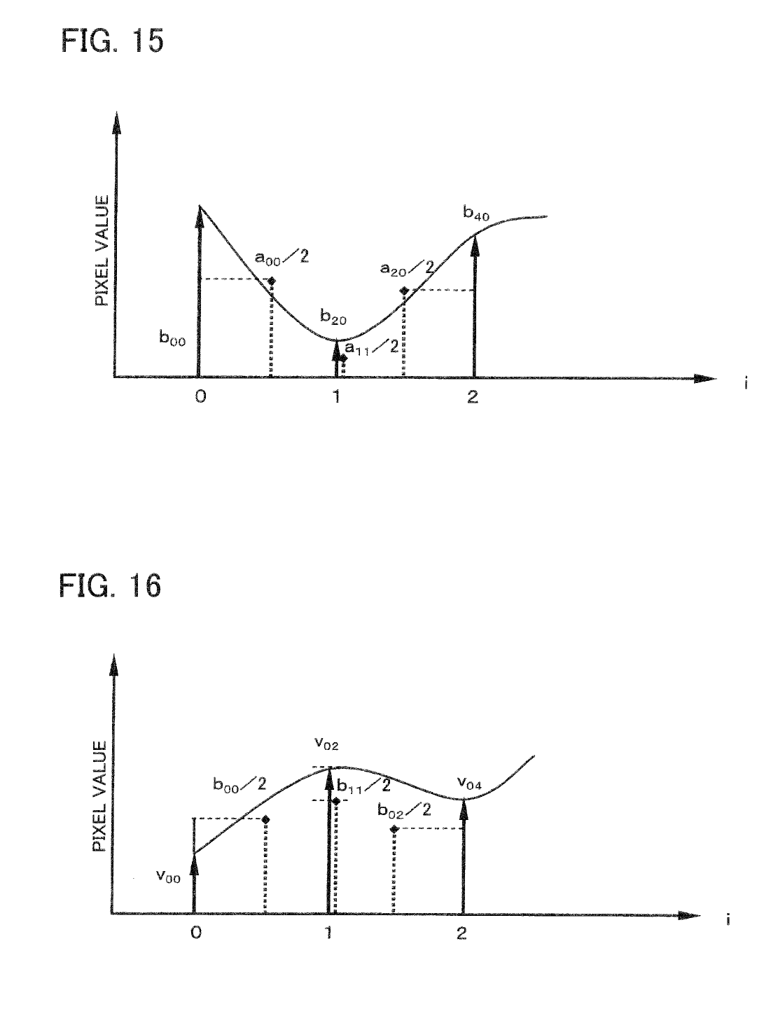

The estimated pixel values vᵢⱼ are estimated as described below. The following description focuses on the estimated pixel values of the G1 pixels. Note that the estimated pixel values of the G2 pixels can be estimated in the same manner as the estimated pixel values of the G1 pixels. When the intermediate estimated pixel values bᵢⱼ in the first column (arranged in the vertical direction) are referred to as b₀₀ and b₀₂ in the shift order (see FIG. 16), the following expression (16) is satisfied.

b₀₀=v₀₀+v₀₂,

b₀₂=v₀₂+v₀₄ (16)

The final estimated pixel value v₀₂ and v₀₄ can be calculated as a function of the final estimated pixel value v₀₀ where the final estimated pixel value v₀₀ is an unknown (initial variable) (see the following expression (17)).

v₀₀=unknown,

v₀₂=b₀₀−v₀₀,

v₀₄=b₀₀+δj₀=b₀₀+(b₀₂−b₀₀) (17)

Note that δj⁰ is the difference between the intermediate pixel values shifted by one shift, and is shown by the following expression (18).

$$\begin{matrix}δ {j}_{0} = {b}_{02} - {b}_{00} \\ = ( {v}_{02} + {v}_{04} ) - ( {v}_{02} + {v}_{00} ) \\ = {v}_{04} - {v}_{00}\end{matrix} \qquad ( 18 )$$

The final estimated pixel value pattern {v₀₀, v₀₂, v₀₄} is compared with the intermediate pixel value pattern {b₀₀, b₁₁, b₀₂} (see the FIG. 16), and an unknown (v₀₀) at which an error between the final estimated pixel value pattern {v₀₀, v₀₂, v₀₄} and the intermediate pixel value pattern {b₀₀, b₁₁, b₀₂} becomes a minimum is derived, and set as the final estimated pixel value v₀₀. The intermediate pixel value pattern {b₀₀, b₁₁, b₀₂} is an intermediate pixel value pattern obtained by combining the intermediate pixel values of the pixels G1 and the pixels G2. More specifically, an evaluation function eᵢⱼ shown by the following expression (19) is calculated as an error evaluation function, and an unknown (v₀₀) at which the value of the evaluation function e₀₀ becomes a minimum is calculated. The final estimated pixel value v₂₀ is calculated by the expression (17) using the calculated final estimated pixel value v₀₀. The final estimated pixel values {v₂₀, v₂₂} and the like can be calculated by applying the above method. The final estimated pixel values {v₀₀, v₀₂, v₂₀, v₂₂} of the high-resolution image are thus calculated.

$${e}_{ij} = {( \frac{{b}_{ij}}{2} - {v}_{ij} )}^{2} + {( \frac{{b}_{( i + 1 ) ( j + 1 )}}{2} - {v}_{i ( j + 2 )} )}^{2} + {( \frac{{b}_{i ( j + 2 )}}{2} - {v}_{i ( j + 4 )} )}^{2} \qquad ( 19 )$$

It is likely that the method that compares the final estimated pixel value pattern with the intermediate pixel value pattern obtained by combining the intermediate pixel values of the pixels G1 and the pixels G2 can easily estimate a higher spatial frequency component as compared with a method that compares the final estimated pixel value pattern with the intermediate pixel value pattern that includes only the intermediate pixel values of the pixels G1. Note that the intermediate pixel value pattern {b₀₀, b₀₂} that includes only the intermediate pixel values of the pixels G1 may be compared with the final estimated pixel value pattern {v₀₀, v₀₂, v₀₄}. It is desirable to appropriately select the intermediate pixel values to be compared with the final estimated pixel value pattern so that the estimation accuracy is improved.

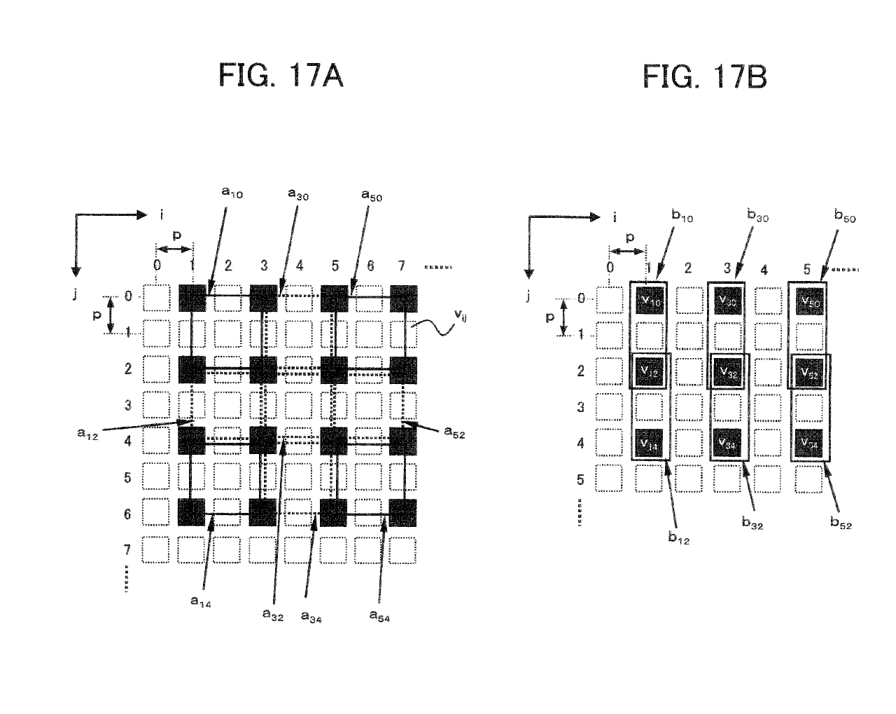

The pixel values of the R pixels and the pixel values of the B pixels are estimated as described below. The following description illustrates an example in which the pixel values of the R pixels are estimated. Note that the pixel values of the B pixels can also be estimated by the following method. As illustrated in FIG. 17A, the 4-pixel sum values {a₁₀, a₅₀, . . . } of the R pixels are sampled as the light-receiving values of the light-receiving units. In FIG. 17A, the R pixels are indicated by a hatched square, the light-receiving units are indicated by a solid line, and the virtual light-receiving units are indicated by a dotted line. The light-receiving values {a₃₀, . . . , a₁₂, a₃₂, . . . } of the R virtual light-receiving units are calculated from the acquired light-receiving values by performing the interpolation process.

FIG. 17B is a view illustrating the intermediate pixels and the estimated pixels. As illustrated in FIG. 17B, the intermediate pixel values {b₁₀, b₃₀, b₅₀, . . . } of the R pixels are estimated. Each intermediate pixel is set to overlap the next intermediate pixel in the vertical direction. The estimated pixel values {v₁₀, v₃₀, v₅₀, . . . } of the R pixels are estimated from the intermediate pixel values. The intermediate pixel values and the estimated pixel values are estimated by a method similar to the method described above with reference to FIGS. 3A to 10. A high-resolution Bayer-array estimated image is obtained by the above process, and a high-resolution RGB frame image is obtained by performing the Bayer interpolation process on the estimated image.

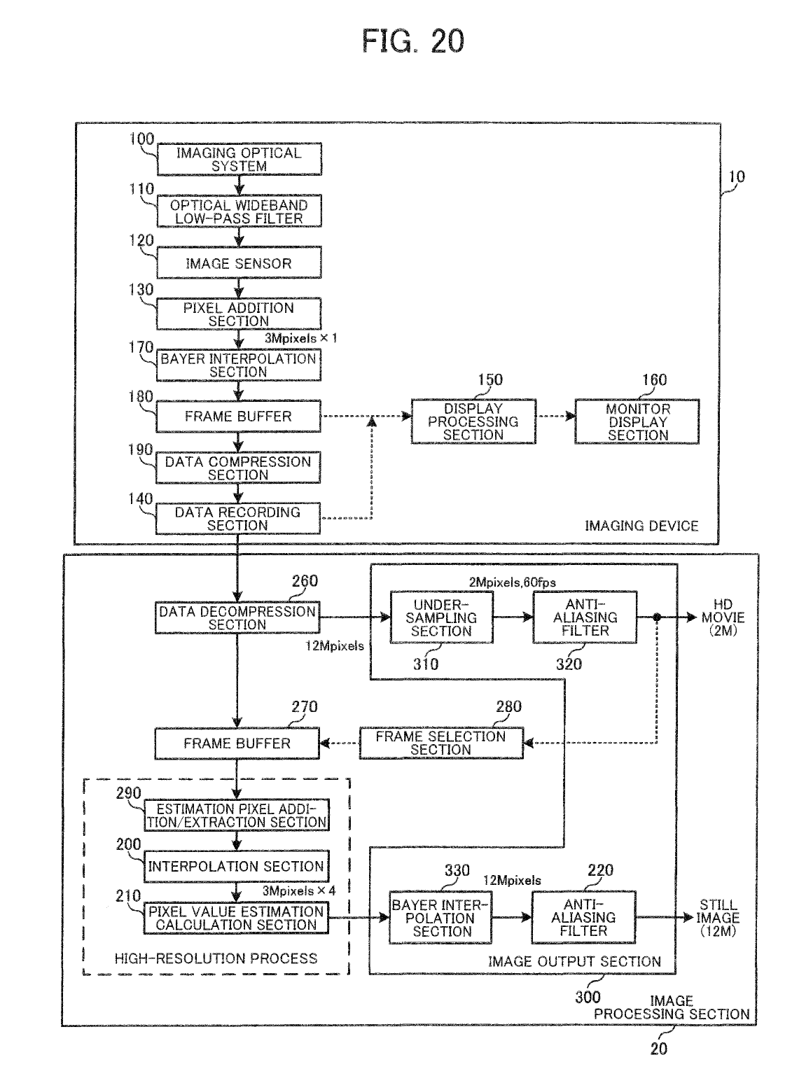

According to the above estimation method, the image sensor may be a color image sensor, and a plurality of pixels of an identical color may be set as the light-receiving units (e.g., the light-receiving units of the G1 pixels and the light-receiving units of the G2 pixels illustrated in FIG. 14A). The pixel values of the plurality of pixels set as the light-receiving units may be summed up, and read (e.g., the G1 light-receiving value a₀₀ and the G2 light-receiving value a₁₁) to acquire a low-resolution frame image. The estimation calculation section (e.g., pixel value estimation calculation section 210 illustrated in FIG. 20) may estimate the pixel value (e.g., v₀₀ and v₂₀) of each pixel of the light-receiving units based on the light-receiving values (e.g., a₀₀ and all) of the light-receiving units of the low-resolution frame image and the light-receiving values (e.g., a₂₀ and a₃₁) of the virtual light-receiving units output from the interpolation section (interpolation section 200). The image output section (image output section 300) may output a high-resolution color frame image based on the estimated pixel values.

This makes it possible to shoot a low-resolution color frame image at a high frame rate, and estimate the pixel values from the low-resolution frame image to acquire a high-resolution color frame image at an arbitrary timing. Since the light-receiving value is acquired by adding up the pixel values of an identical color, it is possible to implement an estimation process that achieves high color reproducibility even if the image has a small color correlation, so that occurrence of a false color due to the estimation process can be suppressed.

### 7. Data Compression/Decompression Process and Estimation Process

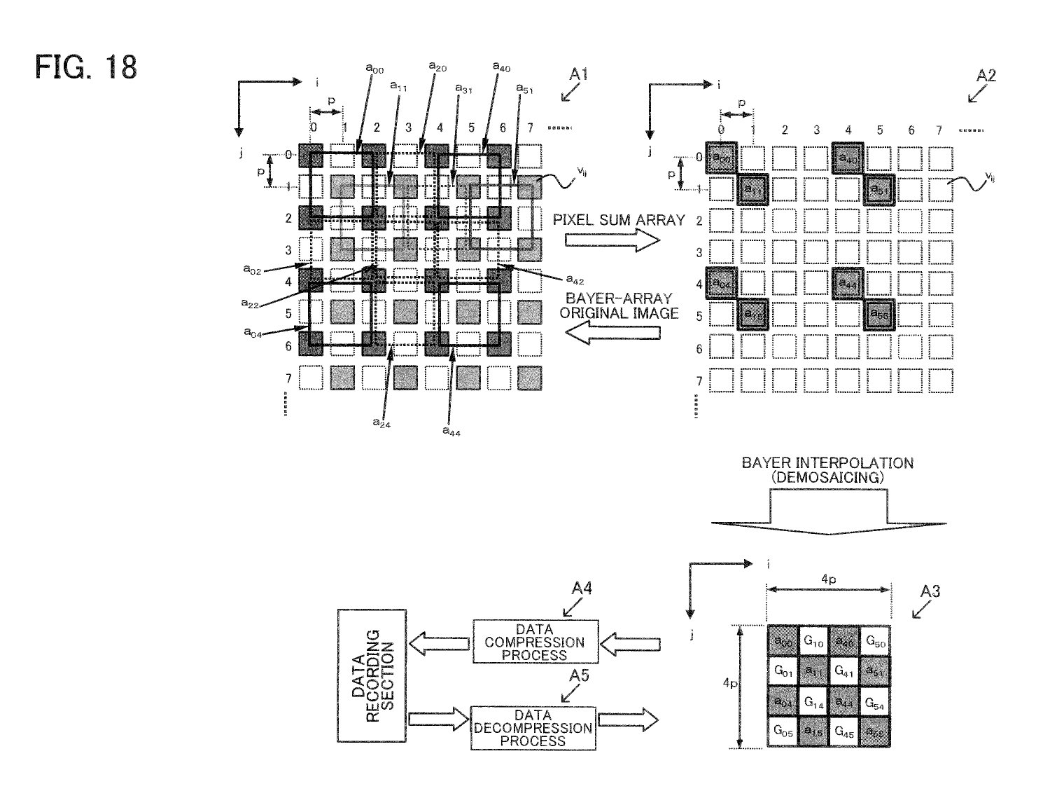

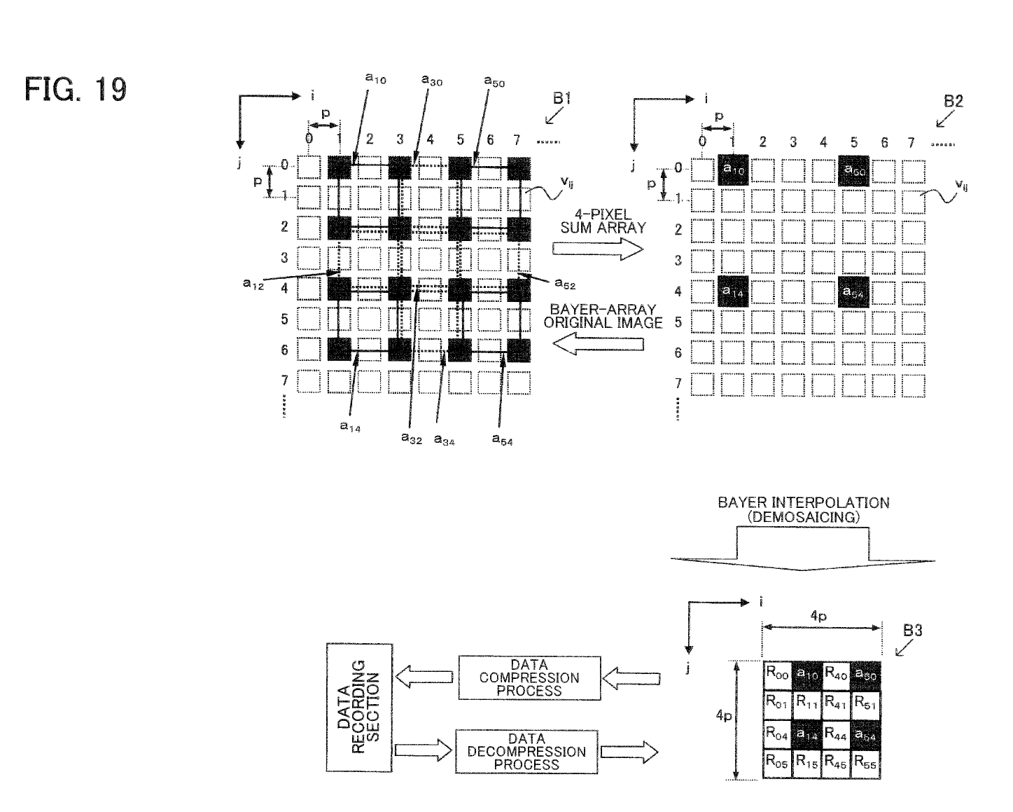

A process that compresses and decompresses a shot low-resolution image, and a process that estimates pixel values from the decompressed low-resolution image are described below with reference to FIGS. 18 and 19.

FIG. 18 is a view illustrating a G-pixel compression/decompression process. As indicated by A1 in FIG. 18, the 4-pixel sum values {a₀₀, a₄₀, a₁₁, a₅₁, . . . } of the G1 pixels and the G2 pixels are acquired. A2 indicates the relationship between the 4-pixel sum values {a₀₀, a₄₀, a₁₁, a₅₁, . . . } and the G pixels of the Bayer-array original image (high resolution). As indicated by A3, the missing pixel values {G₁₀, G₅₀, G₀₁, G₄₁, . . . } are calculated by performing the Bayer interpolation process (demosaicing process). These pixel values are calculated by the interpolation process using the 4-pixel sum values positioned around each missing pixel.

As indicated by A4, data obtained by the Bayer interpolation process is compressed, and recorded in a data recording section. As indicated by A5, the compressed data recorded in the data recording section is decompressed to reproduce the data obtained by the Bayer interpolation process (see A3) when estimating the pixel values of the original image. The estimated pixel values vᵢⱼ are estimated using the values that correspond to the 4-pixel sum values aᵢⱼ instead of the interpolated values Gᵢⱼ. Since the pixels that correspond to the 4-pixel sum values are known when using the Bayer interpolation process, the pixels contained in the decompressed data that are used for the estimation process may be determined in advance.

FIG. 19 is a view illustrating an R-pixel compression/decompression process. Note that a B-pixel compression/decompression process can be implemented in the same manner as the R-pixel compression/decompression process. As indicated by B1 in FIG. 19, the 4-pixel sum values {a₁₀, a₅₀, . . . } of the R pixels are acquired. B2 indicates the relationship between the 4-pixel sum values {a₁₀, a₅₀, . . . } and the R pixels of the Bayer-array original image (high resolution). As indicated by B3, the missing pixel values {R₀₀, R₀₁, R₁₁, R₄₀, R₄₁, R₅₁, . . . } are calculated by performing the Bayer interpolation process. These pixel values are calculated by the interpolation process using the 4-pixel sum values positioned around each missing pixel. The estimated pixel values vᵢⱼ are estimated using the values contained in the decompressed data that correspond to the 4-pixel sum values aᵢⱼ.

### 8. Second Configuration Example of Imaging Device and Image Processing Device

FIG. 20 illustrates a second configuration example of an imaging device and an image processing device that implement the above compression/decompression process. An imaging device 10 illustrated in FIG. 20 includes an imaging optical system 100, an optical wideband low-pass filter 110, an image sensor 120, a pixel addition section 130, a data recording section 140, a display processing section 150, a monitor display section 160, a Bayer interpolation section 170 (demosaicing section), a frame buffer 180, and a data compression section 190. An image processing device 20 includes an interpolation section 200, a pixel value estimation calculation section 210, a data decompression section 260, a frame buffer 270 (storage section), a frame selection section 280, an estimation pixel summation/extraction section 290, and an image output section 300. The image output section 300 includes an under-sampling section 310, anti-aliasing filters 220 and 320, and a Bayer interpolation section 330 (demosaicing section). Note that the same elements as those described above with reference to FIG. 11 are indicated by identical reference signs, and description of these elements is appropriately omitted.

As illustrated in FIG. 20, a low-resolution movie (e.g., 3 Mpixels) acquired by the imaging operation is subjected to the Bayer interpolation process (demosaicing process) by the Bayer interpolation section 170, and buffered in the frame buffer 180. The movie that has been buffered in the frame buffer 180 is compressed by the data compression section 190, and recorded in the data recording section 140.

When playing the recorded data, the movie is decompressed by the data decompression section 260. The decompressed movie is under-sampled by the under-sampling section 310, subjected to the anti-aliasing process by the anti-aliasing filter 320, and played as a High-Vision movie (2 Mpixels).

The user designates the desired high-resolution still image acquisition target frame of the High-Vision movie. The user designates the high-resolution still image acquisition target frame using the frame selection section 280 (e.g., user interface such as a touch panel), and information about the designated frame is input to the frame buffer 270. The low-resolution image at the designated frame is stored in the frame buffer 270. The low-resolution image is an image obtained by the Bayer interpolation process. The light-receiving values (pixel values) used for the estimation process are extracted by the estimation pixel summation/extraction section 290. The extracted light-receiving values are subjected to the interpolation process by the interpolation section 200, and subjected to the estimation process by the pixel value estimation calculation section 210. The estimated pixel values are subjected to the Bayer interpolation process (demosaicing process) by the Bayer interpolation section 330, subjected to the anti-aliasing process by the anti-aliasing filter 220, and output as a high-resolution still image (12 Mpixels).

### 9. Fourth Estimated Pixel Value Estimation Method (Weighted Summation)

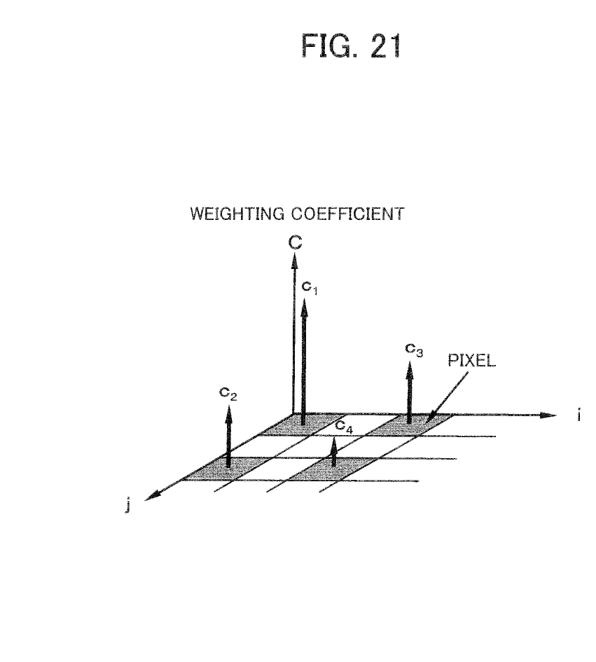

Although an example in which the pixel values of the pixels included in each light-receiving unit are simply summed up and read thereafter has been described above, the pixel values of the pixels included in each light-receiving unit may be summed up with weighting (weighted summation process) and read thereafter, and the estimated pixel values may be calculated from the resulting light-receiving values. A fourth estimated pixel value estimation method that performs the weighted summation process is described below with reference to FIGS. 21 to 28. The following description illustrates an example in which the estimation process is performed on the G1 pixels of the Bayer array. Note that the following estimation process can also be applied to the G2 pixels, the R pixel, and the B pixels.

As illustrated in FIG. 21, weighting coefficients used for the addition readout process are referred to as c₁, c₂, c₃, and c₄. When c₁=1, the weighting coefficients have the relationship shown by the following expression (20) (r is a real number larger than 1).

c₁=1,c₂=1/r,c₃=1/r,c₄=1/r² (20)

The following description illustrates an example in which r=2 (see the following expression (21)) for convenience of explanation.

c₁=1,c₂=½,c₃=½,c₄=¼ (21)

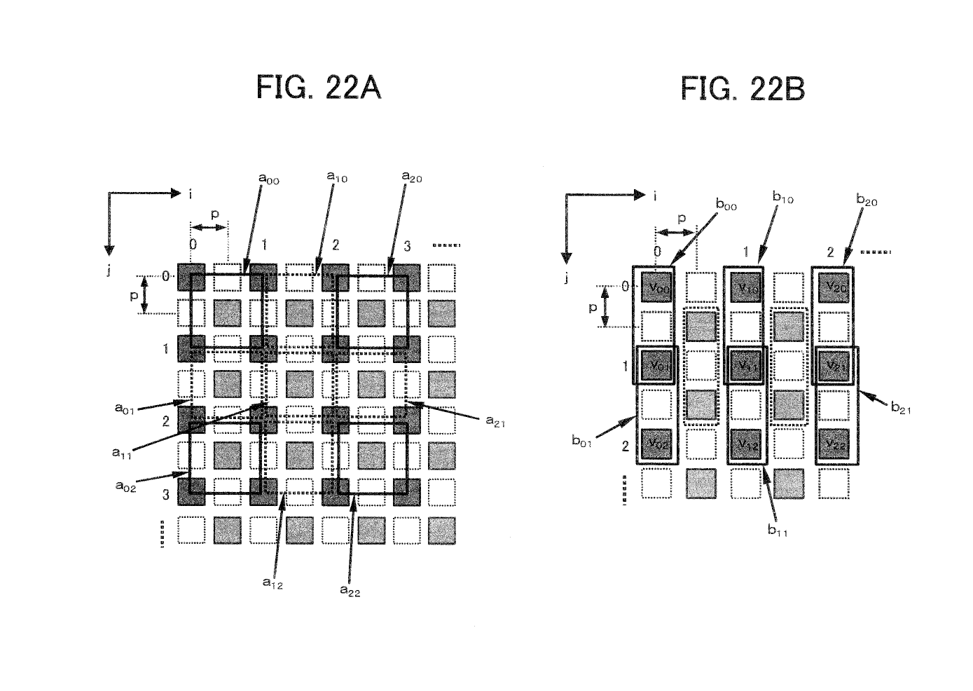

As illustrated in FIG. 22A, the light-receiving values a₀₀, a₂₀, . . . are acquired by the imaging operation, and the light-receiving values a₁₀, . . . , a₀₁, a₁₁, . . . are calculated by the interpolation process. As illustrated in FIG. 22B, the intermediate pixel values b₀₀, b₁₀, . . . are calculated from the light-receiving values, and the estimated pixel values v₀₀, v₁₀, . . . are calculated from the intermediate pixel values b₀₀, b₁₀, . . . . In FIGS. 22A and 22B, the suffix “ij” differs from that illustrated in FIGS. 14A and 14B for convenience of explanation.

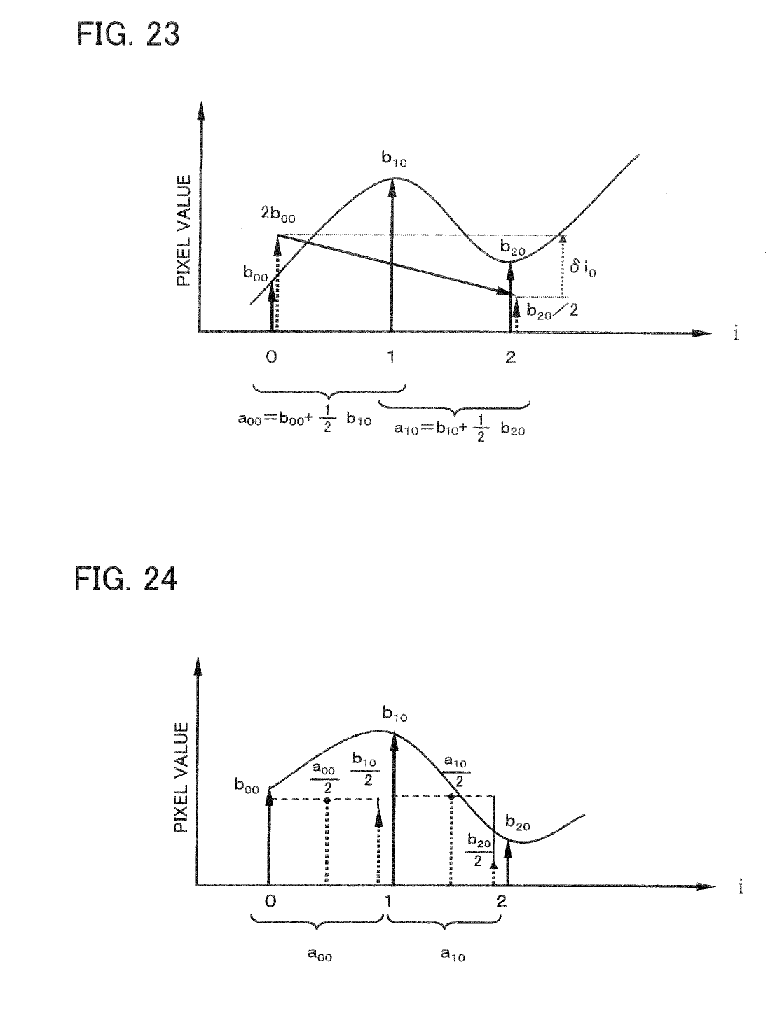

The intermediate pixel values are estimated as described below. When the weighted pixel sum values in the first row (arranged in the horizontal direction) are referred to as a₀₀, a₁₀, and a₂₀ in the shift order, the following expression (22) is satisfied (see FIG. 23).

a₀₀=c₁v₀₀+c₂v₀₁+c₃v₁₀+c₄v₁₁

a₁₀=c₁v₁₀+c₂v₁₁+c₃v₂₀+c₄v₂₁ (22)

The intermediate pixel values b₀₀, b₁₀, and b₂₀ are defined as shown by the following expression (23), and the expression (21) is substituted into the expression (23).

b₀₀=c₁v₀₀+c₂v₀₁=v₀₀+(½)v₀₁,

b₁₀=c₁v₁₀+c₂v₁₁=v₁₀+(½)v₁₁,

b₂₀=c₁v₂₀+c₂v₂₁=v₂₀+(½)^{v}₂₁ (23)

Transforming the expression (22) using the expressions (21) and (23) yields the following expression (24).

a₀₀=v₀₀+(½)v₀₁+(½)v₁₀+(¼)v₁₁=b₀₀+(½)b₁₀,

a₁₀=v₁₀+(½)v₁₁+(½)v₂₀+(¼)v₂₁=b₁₀+(½)b₂₀ (24)

Multiplying the pixel values a₀₀ and a₁₀ in the expression (24) by a given coefficient (given weighting coefficient), calculating the difference δi₀, and transforming the expression using the expression (23) yields the following expression (25).

$$\begin{matrix}δ {i}_{0} = {a}_{10} - 2 {a}_{00} \\ = ( 1 / 2 ) {v}_{20} + ( 1 / 4 ) {v}_{21} - ( 2 {v}_{00} + {v}_{01} ) \\ = ( 1 / 2 ) {b}_{20} - 2 {b}_{00}\end{matrix} \qquad ( 25 )$$

The intermediate pixel values b₁₀ and b₂₀ can be calculated as a function of the intermediate pixel value b₀₀ where the intermediate pixel value b₀₀ is an unknown (see the following expression (26)).

b₀₀=(unknown),

b₁₀=2(a₀₀−b₀₀),

b₂₀=4b₀₀+δi₀=4b₀₀+2(a₁₀−2a₀₀) (26)

A high-resolution intermediate pixel value combination pattern {b₀₀, b₁₀, and b₂₀} is thus calculated where the intermediate pixel value b₀₀ is an unknown (initial variable). Likewise, an intermediate pixel value combination pattern {b₀₁, b₁₁, and b₂₁} (second row) and an intermediate pixel value combination pattern {b₀₂, b₁₂, and b₂₂} (third row) are calculated where the intermediate pixel value b₀₁ or b₀₂ is an unknown.

The unknown (b₀₀) is calculated as described below. As illustrated in FIG. 24, the light-receiving value pattern {a₀₀, a₁₀} is compared with the intermediate pixel value pattern {b₀₀, b₁₀, b₂₀}. An unknown (b₀₀) that minimizes an error between the light-receiving value pattern {a₀₀, a₁₀} and the intermediate pixel value pattern {b₀₀, b₁₀, b₂₀} is derived, and set as the intermediate pixel value b₀₀.

The light-receiving values {a₀₀, a₁₀} are the sum of adjacent values among the intermediate pixel values {b₀₀, b₁₀, b₂₀} that are weighted using a different weighting coefficient (see the expression (24)). Therefore, a correct estimated value cannot be obtained when these values are merely compared. In order to deal with this problem, these values are compared after weighting the intermediate pixel values (see FIG. 24). More specifically, since the intermediate pixel values {bᵢⱼ, b₍ᵢ₊₁₎ⱼ} are weighted using c₃=c₁/2 and c₄=c₂/2, the following expression (27) is satisfied.

aᵢⱼ=bᵢⱼ+(½)b₍ᵢ₊₁₎ⱼ (27)

The evaluation function Ej shown by the following expression (28) is calculated taking account of the weighting shown by the expression (27). The similarity between the light-receiving value pattern {a₀₀, a₁₀} and the intermediate pixel value pattern {b₀₀, b₁₀, b₂₀} is evaluated using the evaluation function Ej.

$${e}_{ij} = {( \frac{{a}_{ij}}{2} - {b}_{ij} )}^{2} + {( \frac{{a}_{ij}}{2} - \frac{{b}_{( i + 1 ) j}}{2} )}^{2} , \\ Ej = {\sum }_{i = 0}^{1} {e}_{ij} \qquad ( 28 )$$

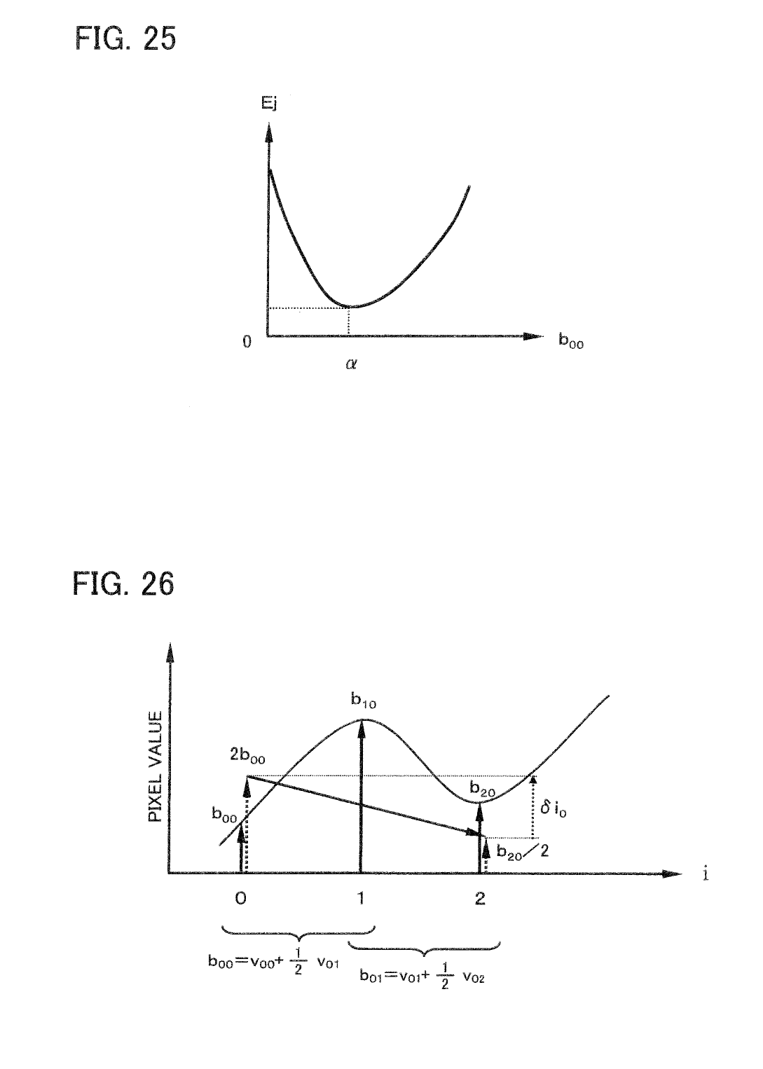

The evaluation function Ej is expressed by a function using the intermediate pixel value b₀₀ as an initial variable (see the expression (26)). Therefore, an unknown (b₀₀) (=α) that minimizes the value of the evaluation function Ej is calculated to determine the intermediate pixel value b₀₀ (see FIG. 25). The estimated intermediate pixel value b₀₀ is substituted into the expression (26) to determine the intermediate pixel values b₁₀ and b₂₀. Since the range of the intermediate pixel value b₀₀ is 0≦b₀₀≦a₀₀, the minimum value of the evaluation function Ej is calculated within this range. Likewise, the intermediate pixel value combination pattern {b₀₁, b₁₁, and b₂₁} (second row) and the intermediate pixel value combination pattern {b₀₂, b₁₂, and b₂₂} (third row) are calculated where the intermediate pixel value b₀₁ or b₀₂ is an unknown.

The final estimated pixel values vᵢⱼ are calculated as described below using the calculated intermediate pixel values bᵢⱼ. The following description is given taking the leftmost column (i=0) illustrated in FIG. 22B as an example for convenience of explanation. As illustrated in FIG. 26, the intermediate pixel values {b₀₁, b₀₁, b₀₂} and the final estimated pixel values {v₀₀, v₀₁, v₀₂} have the relationship shown by the following expression (29).

b₀₀=c₁v₀₀+c₂v₀₁=v₀₀+(½)v₀₁,

b₀₁=c₁v₀₁+c₂v₀₂=v₀₁+(½)v₀₂ (29)

Multiplying the intermediate pixel values b₀₀ and b₀₁ by a given coefficient, and calculating the difference δj₀ yields the following expression (30).

$$\begin{matrix}δ {j}_{0} = {b}_{01} - 2 {b}_{00} \\ = ( {v}_{01} + ( 1 / 2 ) {v}_{02} ) - ( 2 {v}_{00} + {v}_{01} ) \\ = ( 1 / 2 ) {v}_{02} - 2 {v}_{00}\end{matrix} \qquad ( 30 )$$

The final estimated pixel values v₀₁ and v₀₂ are calculated as a function of the estimated pixel value v₀₀ using the expressions (29) and (30) where the estimated pixel value v₀₀ is an unknown (initial variable). The function is shown by the following expression (31).

v₀₀=(unknown),

v₀₁=2(b₀₀−v₀₀),

v₀₂=4v₀₀+2δj₀=4v₀₀+2(b₀₁−2b₀₀) (31)

The estimated pixel value pattern {v₀₀, v₀₁, v₀₂} (see the expression (31)) is compared with the intermediate pixel value pattern {b₀₀, b₀₁}, and the unknown (v₀₀) is derived so that the error Ei becomes a minimum. Since the final estimated pixel values {vᵢⱼ, v₍ᵢ₊ₗ₎ⱼ} are weighted using c₂=c₁/2, the following expression (32) is satisfied.

bᵢⱼ=vᵢⱼ+(½)vᵢ₍ⱼ₊₁₎ (32)

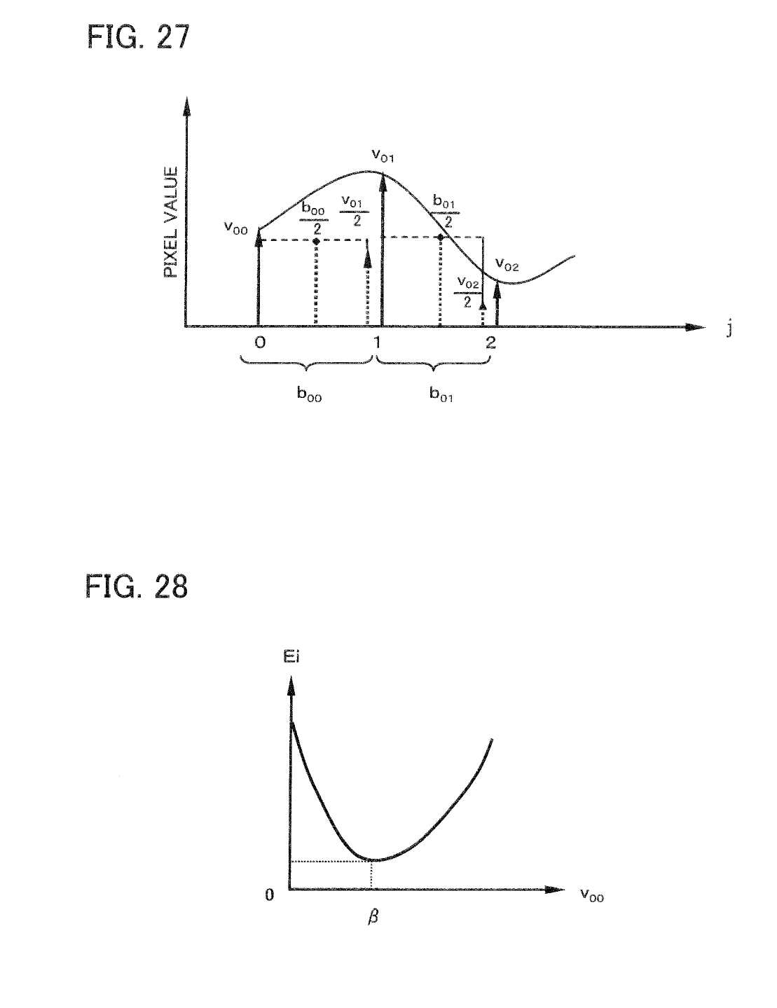

As illustrated in FIG. 27, the patterns are compared taking account of the weighting shown by the expression (32). More specifically, the evaluation function Ej shown by the following expression (33) is calculated.

$${e}_{ij} = {( \frac{{b}_{ij}}{2} - {v}_{ij} )}^{2} + {( \frac{{b}_{ij}}{2} - \frac{{v}_{i ( j + 1 )}}{2} )}^{2} , \\ Ei = {\sum }_{j = 0}^{1} {e}_{ij} \qquad ( 33 )$$

An unknown (v₀₀) (=β) at which the value of the evaluation function Ei becomes a minimum is calculated (see FIG. 28), and the estimated pixel value v₀₀ is substituted into the expression (31) to calculate the final estimated pixel values v₀₁ and v₀₂. Likewise, the final estimated pixel value combination pattern {v₁₀, v₁₁, v₁₂} (second row) is calculated where the estimated pixel value v₁₀ is an unknown.

According to the above estimation method, the light-receiving units may be set to include a plurality of pixels of the image sensor (see FIG. 22A), and the pixel values of each light-receiving unit may be summed up with weighting, and read as the light-receiving values of the light-receiving units (e.g., a₀₀=c₁v₀₀+c₂v₀₁+c₃v₁₀+c₄v₁₁). The estimation calculation section (e.g., pixel value estimation calculation section 210 illustrated in FIG. 20) may estimate the pixel value (e.g., v₀₀) of each pixel of the light-receiving units based on the resulting light-receiving values (e.g., a₀₀) of the light-receiving units and the light-receiving values (e.g., a₁₀) of the virtual light-receiving units obtained by the interpolation process.

This makes it possible to acquire a low-resolution frame image by subjecting the pixel values of each light-receiving unit to the weighted summation process, and estimate the pixel values of a high-resolution frame image from the acquired low-resolution frame image. This makes it possible to improve the reproducibility of the high-frequency components of the object when performing the estimation process. Specifically, when the pixel values of each light-receiving unit are merely summed up, a rectangular window function is used for a convolution. On the other hand, when subjecting the pixel values of each light-receiving unit to the weighted summation process, a window function that contains a large amount of high-frequency components as compared with a rectangular window function is used for a convolution. This makes it possible to acquire a low-resolution frame image that contains a large amount of the high-frequency components of the object, and improve the reproducibility of the high-frequency components in the estimated image.

Note that the pixel values of each light-receiving unit may be simply summed up, and read as the light-receiving values of the light-receiving units (e.g., a₀₀=v₀₀+v₀₁+v₁₀+v₁₁), and the pixel value (e.g., v₀₀) of each pixel of each light-receiving unit may be estimated based on the light-receiving value (e.g., a₀₀) of each light-receiving unit obtained by the addition readout process.

### 10. Fifth Estimated Pixel Value Estimation Method

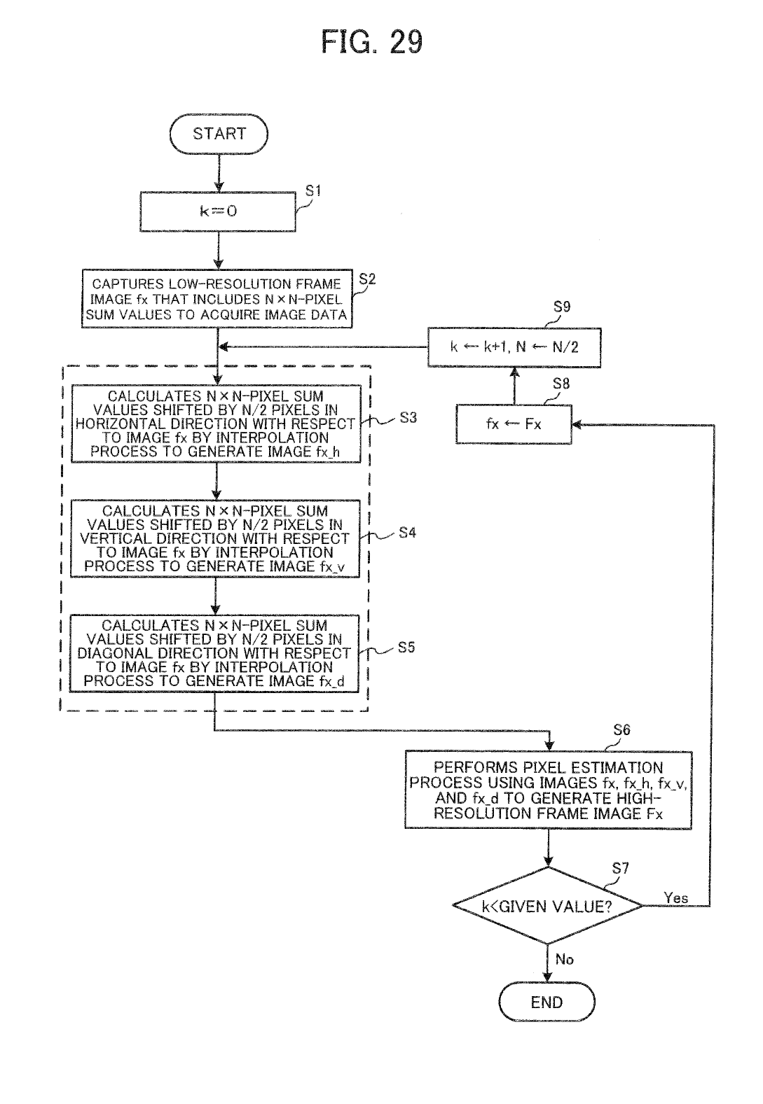

Although an example in which the process that estimates the estimated pixel values is performed once has been described above, the estimation process that increases the number of pixels by a factor of 4 may be repeated a plurality of times to estimate the estimated pixel values. A fifth estimated pixel value estimation method that repeats the estimation process is described below with reference to FIG. 29. Note that the process illustrated in FIG. 29 (flowchart) may be implemented by executing a program, or may be implemented by hardware.

In a step S1, k is set to 0 (k is an integer equal to or larger than 0). A low-resolution frame image fx that includes N×N-pixel sum values (N is a natural number) is acquired (step S2).

N×N-pixel sum values shifted by N/2 pixels in the horizontal direction with respect to the image fx are calculated by the interpolation process to generate an image fx_h (step S3). N×N-pixel sum values shifted by N/2 pixels in the vertical direction with respect to the image fx are calculated by the interpolation process to generate an image fx_v (step S4). N×N-pixel sum values shifted by N/2 pixels in the diagonal direction (horizontal direction and vertical direction) with respect to the image fx are calculated by the interpolation process to generate an image fx_d (step S5).

The estimation process is performed using the images fx, fx_h, fx_v, and fx_d to generate a high-resolution frame image Fx (step S6). When k is smaller than a given value (step S7, Yes), the generated image Fx is set to the image fx (step S8). k is incremented, and N/2 is substituted for N (step S9). The steps S3 to S6 are then repeated. The process ends when k has reached the given value (step S7, No). Note that the given value indicates the number of times that the steps S3 to S6 are repeated, and is a value that corresponds to the resolution of the estimated pixels. For example, when estimating one estimated pixel from 4×4 (=N×N) pixels of the shot image, the given value is 2, and the steps S3 to S6 are repeated twice.

According to the above estimation method, the light-receiving units may be set to include N×N pixels (see the step S2), and the pixel values of the N×N pixels may be summed up, and read to acquire the light-receiving value (image fx) of each N×N-pixel light-receiving unit. The interpolation section (e.g., interpolation section 200 illustrated in FIG. 11) may calculate the light-receiving value (images fx_h, fx_v, and fx_d) of each N×N-pixel virtual light-receiving unit shifted by N/2 pixels by performing the interpolation process (steps S3 to S5). The estimation calculation section (pixel value estimation calculation section 210) may estimate the light-receiving value (image Fx) of each N/2×N/2-pixel light-receiving unit based on the light-receiving value (image fx) of each N×N-pixel light-receiving unit and the light-receiving value (images fx_h, fx_v, and fx_d) of each N×N-pixel virtual light-receiving unit (step S6).

The interpolation section may calculate the light-receiving value (images fx_h, fx_v, and fx_d) of each N/2×N/2-pixel virtual light-receiving unit shifted by N/4 pixels with respect to each N/2×N/2-pixel light-receiving unit by performing the interpolation process (steps S7 to S9 and S3 to S5). The estimation calculation section may estimate the light-receiving value (image Fx) of each N/4×N/4-pixel light-receiving unit based on the light-receiving value (image fx) of each N/2×N/2-pixel light-receiving unit and the light-receiving value (images fx_h, fx_v, and fx_d) of each N/2×N/2-pixel virtual light-receiving unit.

This makes it possible to gradually increase the resolution to the desire resolution by repeating the estimation process that decreases the number of pixels included in each light-receiving unit by a factor of ½×½. Therefore, it is possible to simplify the process as compared with the case where the estimation process that decreases the number of pixels included in each light-receiving unit by a factor of 1/N×1/N is performed once. For example, when estimating a 1×1-pixel estimated pixel from a 4×4-pixel light-receiving unit, three unknowns are included in the relational expression of the intermediate pixel values, so that a complex process is required to estimate the unknowns. According to the above estimation process, since the number of unknowns is one in each estimation process, the unknown can be easily determined.

### 11. Sixth Estimated Pixel Value Estimation Method

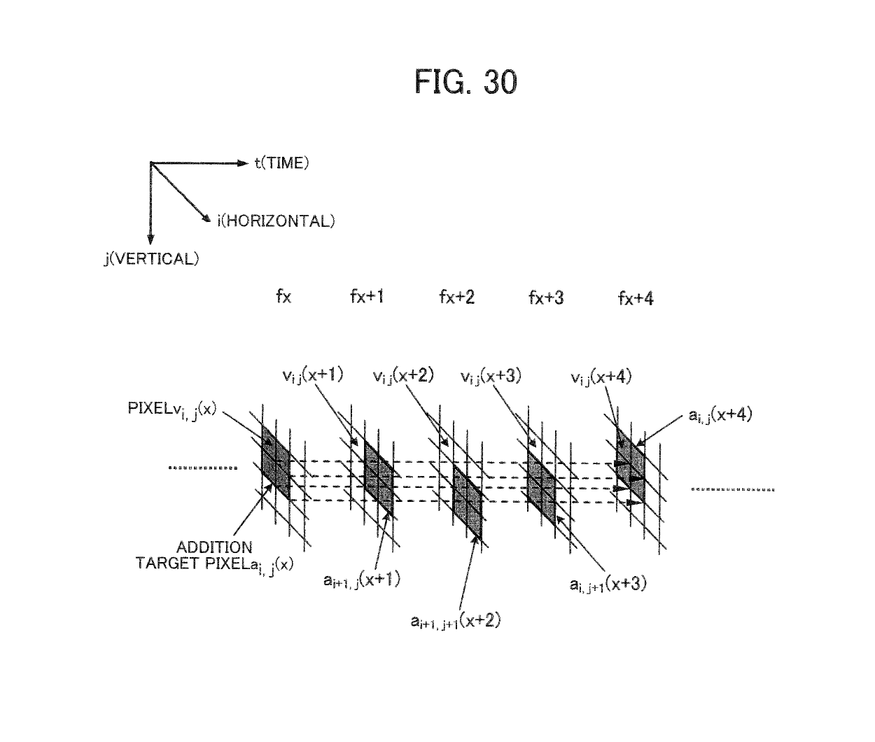

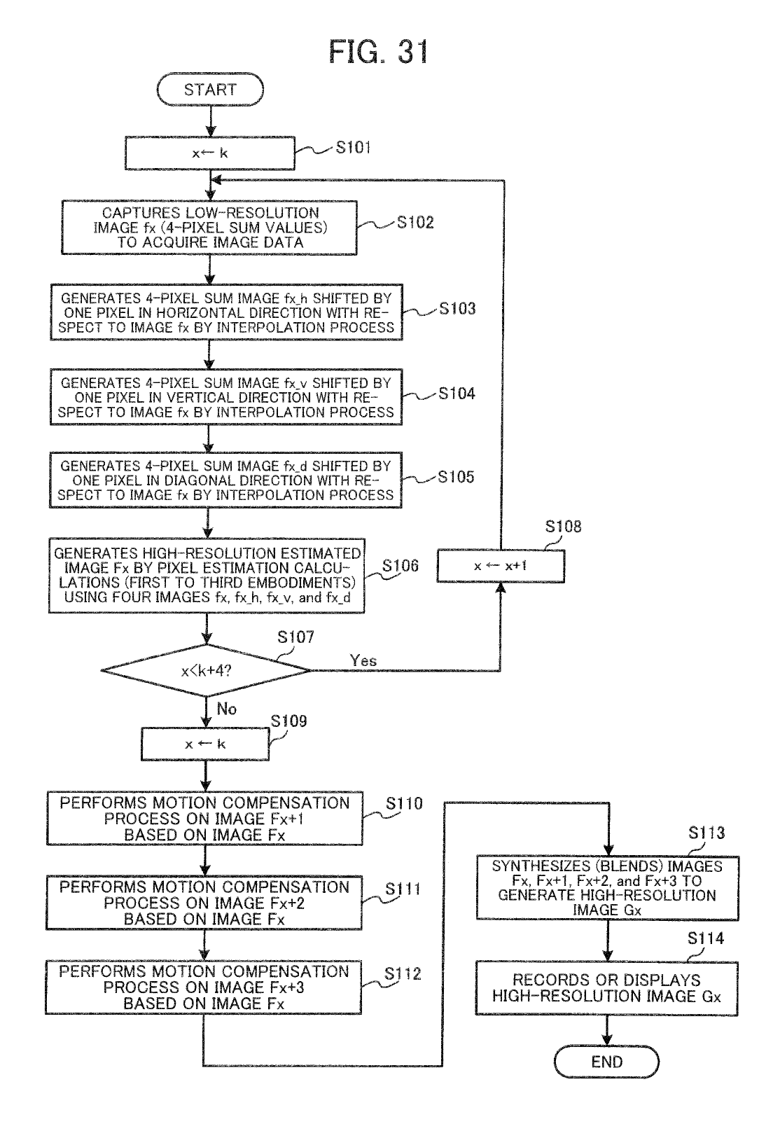

Although an example in which a pixel shift process is not performed when performing the addition readout process has been described above, the addition readout process may be performed while performing a pixel shift process, and a plurality of estimated images may be synthesized (blended) to generate a frame image that has a higher resolution. A sixth estimated pixel value estimation method that performs the addition readout process while performing the pixel shift process is described below with reference to FIGS. 30 and 31.

As illustrated in FIG. 30, the light-receiving value aᵢⱼ(x) is acquired in the frame fx, and the light-receiving value a_{i+1,j}(x+1) (i.e., shifted by one pixel) is acquired in the frame fx+1. The light-receiving value aᵢⱼ(x) is acquired in the frame fx+4. The interpolation process and the estimation process are performed in each frame using the acquired light-receiving values to obtain a high-resolution estimated image in each frame. A motion compensation process is performed on four high-resolution estimated images (four frames) (one pixel shift cycle), and the resulting high-resolution estimated images are synthesized (blended) to output the final high-resolution frame image. The high-resolution estimated images are synthesized (blended) by calculating the average pixel value of each pixel of the four high-resolution estimated images subjected to the motion compensation process. The high-resolution frame image may be output every four frames, or may be output every frame.

FIG. 31 illustrates a detailed flowchart of the estimation process. A frame number k is set to the processing target frame number x (step S101), and a low-resolution frame image fx is acquired (step S102). Images fx_h, fx_v, and fx_d that are shifted by one pixel with respect to the image fx are calculated by the interpolation process (steps S103 to S105), a high-resolution estimated image Fx is estimated based on the images fx, fx_h, fx_v, and fx_d (step S106). When the number of generated high-resolution estimated images Fx is less than 4 (step S107, Yes), the frame number x is incremented (step S108), and the steps S102 to S106 are repeated.

When the number of generated high-resolution estimated images Fx is 4 (step S107, No), the frame number k is set to the frame number x (step S109). The motion compensation process is performed on the high-resolution estimated images Fx+1, Fx+2, and Fx+3 based on the high-resolution estimated image Fx (steps S110 to S112). The high-resolution estimated images Fx, Fx+1, Fx+2, and Fx+3 subjected to the motion compensation process are synthesized (blended) to output a high-resolution frame image Gx (step S113). The high-resolution frame image Gx is stored in a storage device, or displayed on a display device (step S114), and the process ends.

According to the above estimation method, the pixel shift process that shifts the light-receiving units so that overlap occurs may be performed in each frame (fx, fx+1, . . . ), the light-receiving unit is sequentially set at a plurality of positions aᵢⱼ(x), a_{i+1,j}(x+1), . . . by the pixel shift process. The light-receiving unit may be set at an identical position aᵢⱼ(x) and aᵢⱼ(x+4) every multiple frames (every four frames (fx to fx+3)).

The interpolation section (e.g., interpolation section 200 illustrated in FIG. 11) may calculate the light-receiving values a_{i+1,j}(x), a_{i+2,j}(x+1), . . . of the virtual light-receiving units in each frame by the interpolation process based on the low-resolution frame image acquired in each frame. The estimation calculation section (pixel value estimation calculation section 210) may estimate the estimated pixel values vᵢⱼ(x), vᵢⱼ(x+1), . . . in each frame based on the light-receiving value of the light-receiving unit and the light-receiving values of the virtual light-receiving units. The image output section (image output section 300) may calculate the frame image (high-resolution estimated image) in each frame based on the estimated pixel values vᵢⱼ(x), vⱼᵢ(x+1), . . . , and may synthesize (blend) the frame images in a plurality of frames (fx to fx+3) to output a high-resolution frame image.

According to the above configuration, the high-resolution frame image is estimated from a plurality of low-resolution frame image acquired performing the pixel shift process in each frame. Since high-frequency components due to the pixel shift process can be added, the reproducibility of the high-frequency components of the image can be improved as compared with the case where the pixel shift process is not performed.

### 12. Seventh Estimated Pixel Value Estimation Method

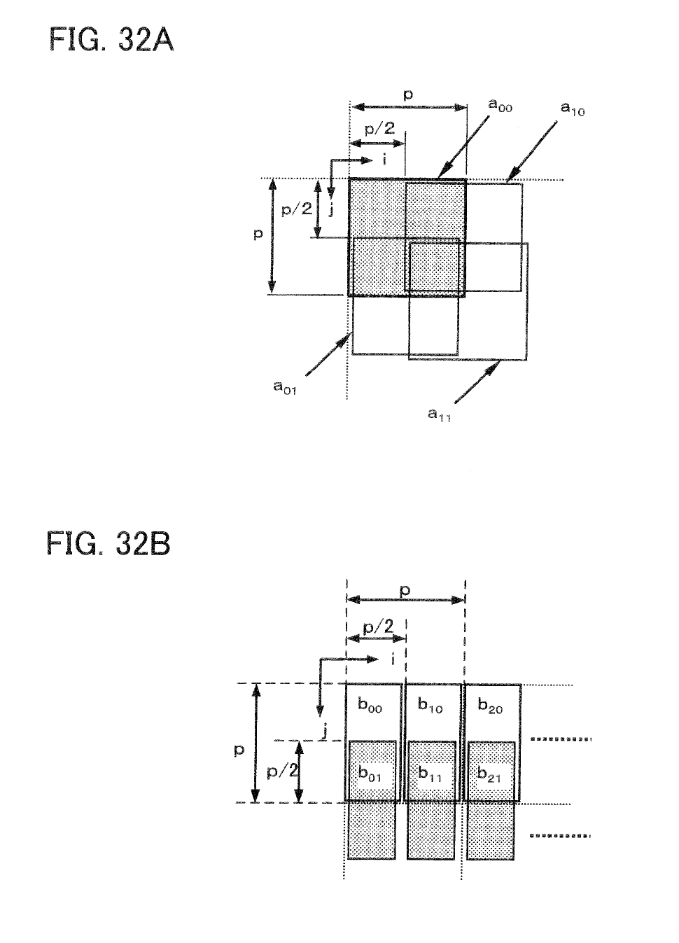

The above embodiments have been described taking an example in which the light-receiving unit includes a plurality of pixels, and an image that has a resolution equal to that of the image sensor is estimated from the light-receiving value of the light-receiving unit, the light-receiving unit may include one pixel, and an image that has a resolution (number of pixels) higher (larger) than that of the image sensor may be estimated. A seventh estimated pixel value estimation method that estimates such an image is described below with reference to FIGS. 32A and 32B.

As illustrated in FIG. 32A, the pixel pitch of the image sensor is p, and the light-receiving units are set every pixel at a pitch of p. Specifically, the light-receiving value of each light-receiving unit is the pixel value of the pixel set as each light-receiving unit. The light-receiving value a₀₀ is read from the light-receiving unit, and the light-receiving values a₁₀, a₀₁, and a₁₁ of the virtual light-receiving units are calculated by the interpolation process. The estimated pixel values corresponding to the pixels at a pitch of p/2 are estimated from the light-receiving values a₀₀, a₁₀, a₀₁, and a₁₁ to calculate a high-resolution frame image. This high-resolution process may be applied when increasing the resolution of a digital zoom image or a trimmed image, for example.

FIG. 32B is a view illustrating the intermediate pixels. As illustrated in FIG. 32B, the intermediate pixel values b₀₀ to b₂₁ are estimated from the light-receiving values a₀₀ to a₁₁. The pixel pitch of the intermediate pixel values b₀₀ to b₂₁ in the horizontal direction (or the vertical direction) is p/2. The intermediate pixel values b₀₀ to b₂₁ and the final estimated pixel values are estimated in the same manner as described above.

### 13. Third Configuration Example of Imaging Device and Image Processing Device

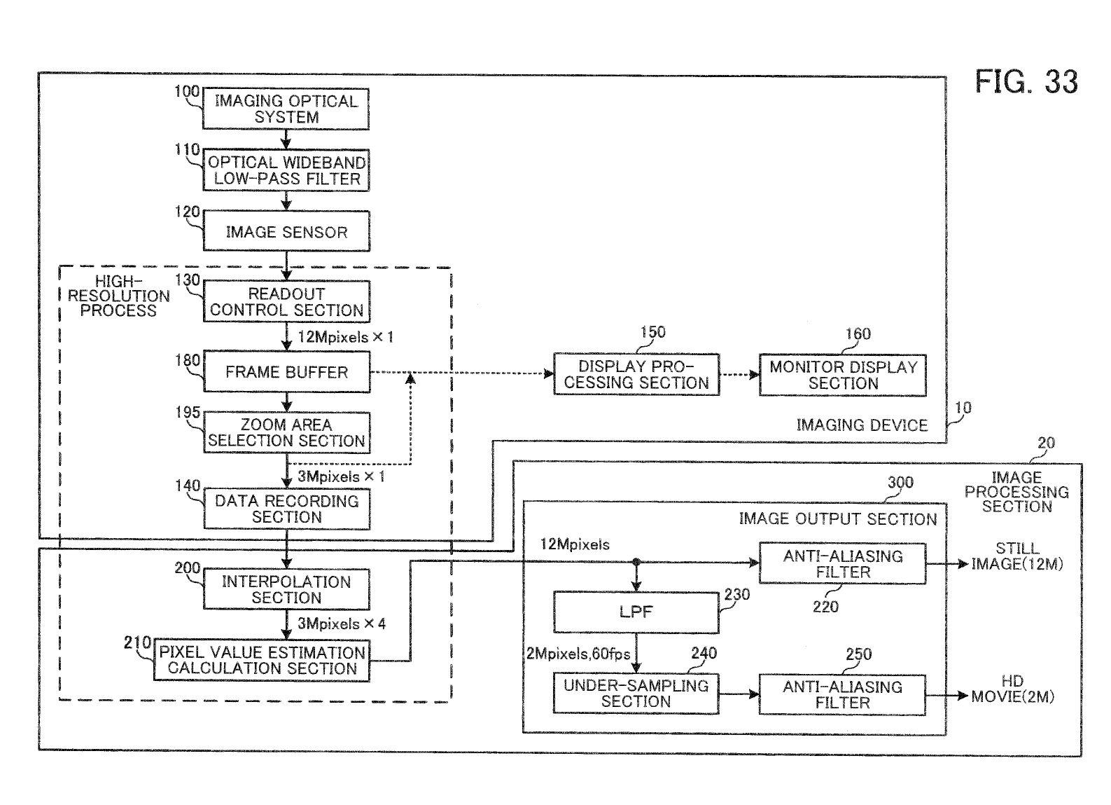

FIG. 33 illustrates a third configuration example of an imaging device and an image processing device when performing the high-resolution process on a digital zoom image. An imaging device 10 illustrated in FIG. 33 includes an imaging optical system 100, an optical wideband low-pass filter 110, an image sensor 120, a readout control section 130, a data recording section 140, a display processing section 150, a monitor display section 160, a frame buffer 180, and a zoom area selection section 195. An image processing device 20 illustrated in FIG. 33 includes an interpolation section 200, a pixel value estimation calculation section 210, and an image output section 300. The image output section 300 includes anti-aliasings filters 220 and 250, a low-pass filter 230, and an under-sampling section 240. Note that the same elements as those described above with reference to FIG. 11 and the like are indicated by identical reference signs, and description thereof is appropriately omitted.

As illustrated in FIG. 33, the light-receiving unit is set to one pixel by the readout control section 130, and the pixel values of the image sensor 120 (e.g., 12 Mpixels) are read to acquire a captured image (12 Mpixels). A zoom area is set to the captured image, and the image (3 Mpixels) in the zoom area is acquired as a low-resolution frame image. The zoom area is selected by the user via a user interface (not illustrated in FIG. 33), for example. The low-resolution frame image is stored in the data recording section 140. The interpolation process and the estimation process are performed on the low-resolution frame image read from the data recording section 140 to calculate an estimated image (12 Mpixels). The image output section 300 generates a high-resolution still image (12 Mpixels) or a High-Vision movie (2 Mpixels) from the estimated image.

Although some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. Any term (e.g., pixel-sum value, interpolated light-receiving unit, or intermediate estimated pixel value) cited with a different term having a broader meaning or the same meaning (e.g., light-receiving unit, virtual light-receiving unit, or intermediate pixel value) at least once in the specification and the drawings can be replaced by the different term in any place in the specification and the drawings. The configurations and the operations of the interpolation section, the estimation calculation section, the image output section, the imaging device, the image processing device, and the like are not limited to those described in connection with the above embodiments. Various modifications and variations may be made.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

What is claimed is:

1. An image processing device comprising:
a storage section that stores a low-resolution frame image being acquired by reading light-receiving values of light-receiving units, the light-receiving units being units for acquiring the light-receiving values and set on an image sensor;
an interpolation section that calculates light-receiving values of virtual light-receiving units by an interpolation process based on the light-receiving values of the light-receiving units of the low-resolution frame image, the virtual light-receiving units being set to overlap a corresponding light-receiving unit and being shifted from a position of the corresponding light-receiving unit;
an estimation calculation section that estimates estimated pixel values at a pixel pitch smaller than that of the low-resolution frame image based on the light-receiving value of the corresponding light-receiving unit and the light-receiving values of the virtual light-receiving units; and
an image output section that outputs a high-resolution frame image having a resolution higher than that of the low-resolution frame image based on the estimated pixel values estimated by the estimation calculation section.

2. The image processing device as defined in claim 1,
the estimation calculation section calculating a difference between the light-receiving value of a first light-receiving unit and the light-receiving value of a second light-receiving unit, and estimating the estimated pixel values based on the difference, the first light-receiving unit being the corresponding light-receiving unit or a virtual light-receiving unit among the virtual light-receiving units that is set at a first position, and the second light-receiving unit being a virtual light-receiving unit among the virtual light-receiving units that is set at a second position and overlaps the first light-receiving unit.

3. The image processing device as defined in claim 2,
the estimation calculation section expressing a relational expression of a first intermediate pixel value and a second intermediate pixel value using the difference, the first intermediate pixel value being the light-receiving value of a first light-receiving area that is obtained by removing an overlapping area from the first light-receiving unit, and the second intermediate pixel value being the light-receiving value of a second light-receiving area that is obtained by removing the overlapping area from the second light-receiving unit, and
the estimation calculation section estimating the first intermediate pixel value and the second intermediate pixel value using the relational expression, and calculating the estimated pixel values using the estimated first intermediate pixel value.

4. The image processing device as defined in claim 3,
the estimation calculation section expressing a relational expression of intermediate pixel values included in an intermediate pixel value pattern using the light-receiving value of the corresponding light-receiving unit and the light-receiving values of the virtual light-receiving units, the intermediate pixel value pattern including consecutive intermediate pixel values that include the first intermediate pixel value and the second intermediate pixel value,
the estimation calculation section comparing the intermediate pixel value pattern expressed by the relational expression and a light-receiving value pattern expressed using the light-receiving value of the corresponding light-receiving unit and the light-receiving values of the virtual light-receiving units to evaluate similarity, and
the estimation calculation section determining the intermediate pixel values included in the intermediate pixel value pattern based on a similarity evaluation result so that the similarity becomes a maximum.

5. The image processing device as defined in claim 4,
the estimation calculation section calculating an evaluation function that indicates an error between the intermediate pixel value pattern expressed by the relational expression and the light-receiving value pattern, and determining the intermediate pixel values included in the intermediate pixel value pattern so that a value of the evaluation function becomes a minimum.

6. The image processing device as defined in claim 1,
the interpolation section calculating a weighted sum of the light-receiving values of a plurality of light-receiving units that are included in the low-resolution frame image and positioned around each of the virtual light-receiving units to calculate the light-receiving values of the virtual light-receiving units.

7. The image processing device as defined in claim 1,
the light-receiving units being set to include a plurality of pixels of the image sensor, and pixel values of the plurality of pixels respectively included in the light-receiving units being summed up, and read as the light-receiving values of the light-receiving units, and
the estimation calculation section estimating the pixel values of the plurality of pixels respectively included in the light-receiving units based on the light-receiving values of the light-receiving units.

8. The image processing device as defined in claim 1,
the light-receiving units being set to include a plurality of pixels of the image sensor, and pixel values of the plurality of pixels respectively included in the light-receiving units being summed up with weighting, and read as the light-receiving values of the light-receiving units, and
the estimation calculation section estimating the pixel values of the plurality of pixels respectively included in the light-receiving units based on the light-receiving values of the light-receiving units.

9. The image processing device as defined in claim 1,
the image sensor being a color image sensor, a plurality of pixels adjacent to each other being set as the light-receiving units independently of a color of each pixel, and pixel values of the plurality of pixels set as the light-receiving units being summed up, and read to acquire the low-resolution frame image,
the estimation calculation section estimating the pixel values of each pixel of the light-receiving units based on the light-receiving values of the light-receiving units of the low-resolution frame image and the light-receiving values of the virtual light-receiving units output from the interpolation section, and
the image output section outputting a high-resolution color frame image based on the pixel values estimated by the estimation calculation section.

10. The image processing device as defined in claim 1,
the image sensor being a color image sensor, a plurality of pixels in an identical color being set as the light-receiving units, and pixel values of the plurality of pixels set as the light-receiving units being summed up, and read to acquire the low-resolution frame image,
the estimation calculation section estimating the pixel value of each pixel of the light-receiving units based on the light-receiving values of the light-receiving units of the low-resolution frame image and the light-receiving values of the virtual light-receiving units output from the interpolation section, and
the image output section outputting a high-resolution color frame image based on the pixel values estimated by the estimation calculation section.

11. The image processing device as defined in claim 1,
the light-receiving units being set to include N×N pixels, and pixel values of the N×N pixels being summed up, and read to acquire the light-receiving value of each N×N-pixel light-receiving unit,
the interpolation section calculating the light-receiving value of each N×N-pixel virtual light-receiving unit shifted by N/2 pixels with respect to each N×N-pixel light-receiving unit by performing the interpolation process,
the estimation calculation section estimating the light-receiving value of each N/2×N/2-pixel light-receiving unit based on the light-receiving value of each N×N-pixel light-receiving unit and the light-receiving value of each N×N-pixel virtual light-receiving unit,
the interpolation section calculating the light-receiving value of each N/2×N/2-pixel virtual light-receiving unit shifted by N/4 pixels with respect to each N/2×N/2-pixel light-receiving unit by performing the interpolation process, and
the estimation calculation section estimating the light-receiving value of each N/4×N/4-pixel light-receiving unit based on the light-receiving value of each N/2×N/2-pixel light-receiving unit and the light-receiving value of each N/2×N/2-pixel virtual light-receiving unit.

12. The image processing device as defined in claim 1,
a pixel shift process that shifts the light-receiving units so that overlap occurs being performed in each frame, and the corresponding light-receiving unit being sequentially set at a plurality of positions by the pixel shift process, and set at an identical position at intervals of a plurality of frames,
the interpolation section calculating the light-receiving values of the virtual light-receiving units in each frame by the interpolation process based on the low-resolution frame image acquired in each frame,
the estimation calculation section estimating the estimated pixel values in each frame based on the light-receiving value of the corresponding light-receiving unit and the light-receiving values of the virtual light-receiving units, and
the image output section calculating a frame image in each frame based on the estimated pixel values, and synthesizing the frame images in the plurality of frames to output the high-resolution frame image.

13. The image processing device as defined in claim 1,
the image output section performing a resolution conversion process on the high-resolution frame image to output a High-Vision movie, or outputting the high-resolution frame image as a high-resolution still image.

14. An imaging device comprising:
an image sensor;
a readout control section that acquires a low-resolution frame image by reading light-receiving values of light-receiving units, the light-receiving units being units for acquiring the light-receiving values and set on the image sensor;
a storage section that stores the low-resolution frame image acquired by the readout control section;
an interpolation section that calculates light-receiving values of virtual light-receiving units by an interpolation process based on the light-receiving values of the light-receiving units of the low-resolution frame image, the virtual light-receiving units being set to overlap a corresponding light-receiving unit and being shifted from a position of the corresponding light-receiving unit;
an estimation calculation section that estimates estimated pixel values at a pixel pitch smaller than that of the low-resolution frame image based on the light-receiving value of the corresponding light-receiving unit and the light-receiving values of the virtual light-receiving units; and
an image output section that outputs a high-resolution frame image having a resolution higher than that of the low-resolution frame image based on the estimated pixel values estimated by the estimation calculation section.

15. The imaging device as defined in claim 14, further comprising:
a display section; and
a display control section that displays an image on the display section,
the image output section performing a resolution conversion process on the high-resolution frame image to output a High-Vision movie, or outputting the high-resolution frame image as a high-resolution still image, and
the display control section displaying a movie that includes the low-resolution frame image, displaying the High-Vision movie, and displaying the high-resolution still image.

16. An information storage device that stores a program, the program that causes a computer to function as: a storage section that stores a low-resolution frame image being acquired by reading light-receiving values of light-receiving units, the light-receiving units being units for acquiring the light-receiving values and set on an image sensor;
an interpolation section that calculates light-receiving values of virtual light-receiving units by an interpolation process based on the light-receiving values of the light-receiving units of the low-resolution frame image, the virtual light-receiving units being set to overlap a corresponding light-receiving unit and being shifted from a position of the corresponding light-receiving unit;
an estimation calculation section that estimates estimated pixel values at a pixel pitch smaller than that of the low-resolution frame image based on the light-receiving value of the corresponding light-receiving unit and the light-receiving values of the virtual light-receiving units; and
an image output section that outputs a high-resolution frame image having a resolution higher than that of the low-resolution frame image based on the estimated pixel values estimated by the estimation calculation section.

17. An image processing method comprising:
storing a low-resolution frame image being acquired by reading light-receiving values of light-receiving units, the light-receiving units being units for acquiring the light-receiving values and set on an image sensor;
calculating light-receiving values of virtual light-receiving units by an interpolation process based on the light-receiving values of the light-receiving units of the low-resolution frame image, the virtual light-receiving units being set to overlap a corresponding light-receiving unit and being shifted from a position of the corresponding light-receiving unit;
estimating estimated pixel values at a pixel pitch smaller than that of the low-resolution frame image based on the light-receiving value of the corresponding light-receiving unit and the light-receiving values of the virtual light-receiving units; and
outputting a high-resolution frame image having a resolution higher than that of the low-resolution frame image based on the estimated pixel values.
